(19) United States
(12) Patent Application Publication
(10) Pub. No.: US 2025/0226619 A1
(43) Pub. Date: Jul. 10, 2025

(54) Electrical Connector

(71) Applicants: Dongguan Tarng Yu Electronics Co., Ltd., Dongguan City (CN); Tarng Yu Enterprise co., ltd., New Taipei City (TW)

(72) Inventors: YING-CHUNG CHEN, New Taipei City (TW); MU-JUNG HUANG, New Taipei City (TW)

(21) Appl. No.: 19/006,907

(22) Filed: Dec. 31, 2024

(30) Foreign Application Priority Data
Jan. 5, 2024 (CN) 202420028801.8
Jan. 5, 2024 (CN) 202420028806.0

(51) Int. Cl. H01R 13/6597; H01R 13/6581

(52) U.S. Cl. CPC H01R 13/6597; H01R 13/6581

(57) ABSTRACT

An electrical connector is described that provides a shielding wall for at least three sides of non-grounded conductive terminals, enabling the transmission of shielded signals. This design effectively reduces interference for the electrical connector when transmitting high-speed signals, thereby optimizing the transmission quality of high-speed signals for the electrical connector. This meets the specific requirements and advancements in electronic devices.

### CROSS-REFERENCE TO RELATED APPLICATIONS

This application claims the priority of China Patent Application No. 202420028801.8 and No. 202420028806.0 filed on Jan. 5, 2024, in the State Intellectual Property Office of China, the disclosure of which is incorporated herein by reference.

### BACKGROUND OF THE INVENTION

### Field of the Invention

This application relates to the field of electronic device technology, more specifically, to an electrical connector aimed at reducing interference levels when transmitting high-speed signals.

### Descriptions of the Related Art

In recent years, electrical connectors have been widely used in various electronic devices to transmit signals through a plurality of conductive terminals on the connector. However, with the special requirements and development of electronic devices, there may also be a need for the plurality of conductive terminals of the electrical connector to transmit high-speed signals. Currently, electrical connectors are prone to interference when transmitting high-speed signals (such interference may include external electromagnetic interference or crosstalk interference between the plurality of conductive terminals of the connector), resulting in attenuation of the transmitted high-speed signals of the electrical connectors.

From the above we can know addressing the issue of electrical connectors being prone to interference during the transmission of high-speed signals is a pressing concern for professionals in the field.

### SUMMARY OF THE INVENTION

In view of the drawbacks of the prior art mentioned above, the present application provides an electrical connector, wherein one side of the electrical connector is an electrical connector major side, comprising: a major conductive terminal assembly located on the electrical connector major side, comprising a major first grounding conductive terminal, a major second grounding conductive terminal, and a major non-grounding conductive terminal; a major insulation terminal base comprising a major non-grounding terminal installation structure, wherein the major non-grounding terminal installation structure provides for the installation of the major non-grounding conductive terminal to form a major non-grounding conductive terminal installation module; a conductive plastic base for supporting the major non-grounding conductive terminal installation module to form a major grounding conductive terminal installation module, and the conductive plastic base comprises a major conductive plastic base body, a major first conductive plastic wall structure, and a major second conductive plastic wall structure, and the major conductive plastic base body electrically connects to the major first conductive plastic wall structure and the major second conductive plastic wall structure, and the major grounding conductive terminal installation module comprises a major first grounding terminal installation structure and a major second grounding terminal installation structure, wherein the major first grounding terminal installation structure is provided for installing the major first grounding conductive terminal and the major second grounding terminal installation structure is provided for installing the major second grounding conductive terminal, allowing the major non-grounding conductive terminal to be positioned between the major first grounding conductive terminal and the major second grounding conductive terminal, in the major grounding conductive terminal installation module, the major first conductive plastic wall structure is abutted against the major first grounding conductive terminal, and the major second conductive plastic wall structure is abutted against the major second grounding conductive terminal to allow the conductive plastic base to electrically connect to the major first grounding conductive terminal and the major second grounding conductive terminal, enabling the major conductive plastic base body, the major first conductive plastic wall structure, the major second conductive plastic wall structure, the major first grounding conductive terminal, and the major second grounding conductive terminal to form a major non-grounding terminal shielding wall, and the major non-grounding terminal shielding wall comprises a U-shaped cross-section, allowing the major non-grounding terminal shielding wall to provide a shielding wall on at least three sides of the major non-grounding conductive terminal.

Preferably, the electrical connector said above, wherein the front end of the electrical connector is an electrical connector front end, and the electrical connector further comprises a major front conductive connecting body, wherein the major front conductive connecting body extends at the electrical connector front end and spans over the major non-grounding conductive terminal, electrically connecting to the major first grounding conductive terminal and the major second grounding conductive terminal, enabling the major front conductive connecting body to electrically connect to the major non-grounding terminal shielding wall, thereby providing electrical shielding to the major non-grounding conductive terminal at the electrical connector front end, wherein the major first grounding conductive terminal comprises a major first grounding terminal front joining structure, the major second grounding conductive terminal comprises a major second grounding terminal front joining structure, and the major non-grounding conductive terminal comprises a major non-grounding terminal front joining structure, additionally, the major first grounding terminal front joining structure, the major second grounding terminal front joining structure, and the major non-grounding terminal front joining structure are respectively located at the electrical connector front end.

Preferably, the electrical connector said above, wherein the major front conductive connector comprises a major front wall shielding structure, and the major front wall shielding structure provides a shielding wall for the major non-grounding conductive terminal at the electrical connector front end.

Preferably, the electrical connector said above, wherein the major front conductive connector comprises a major front connector hollow structure, and the major front connector hollow structure is hollowed out at the electrical connector front end to provide impedance matching for the major non-grounding conductive terminal.

Preferably, the electrical connector said above, wherein the major conductive plastic base body extends around one side of the major non-grounding conductive terminal.

Preferably, the electrical connector said above, wherein the major first grounding conductive terminal is inserted into the major first conductive plastic wall structure, and the major second grounding conductive terminal is inserted into the major second conductive plastic wall structure, allowing the major first grounding conductive terminal and the major second grounding conductive terminal to electrically connect to the conductive plastic base.

Preferably, the electrical connector said above, wherein the major first conductive plastic wall structure and the major second conductive plastic wall structure respectively enter the major insulation terminal base, allowing the major first conductive plastic wall structure to abut against the major first grounding conductive terminal and allowing the major second conductive plastic wall structure to abut against the major second grounding conductive terminal.

Preferably, the electrical connector said above, wherein the major first conductive plastic wall structure abuts against the major first grounding conductive terminal in surface contact and the major second conductive plastic wall structure abuts against the major second grounding conductive terminal in surface contact, providing structural support for the major first grounding conductive terminal and the major second grounding conductive terminal respectively.

Preferably, the electrical connector said above, wherein the other side of the electrical connector is an electrical connector minor side, wherein the conductive plastic base also comprises a minor conductive plastic base body, a minor first conductive plastic wall structure, and a minor second conductive plastic wall structure, and the minor conductive plastic base body electrically connects to the minor first conductive plastic wall structure and the minor second conductive plastic wall structure, and the electrical connector further comprises: a minor conductive terminal assembly, located on the electrical connector minor side, comprising a minor first grounding conductive terminal, a minor second grounding conductive terminal, and a minor non-grounding conductive terminal; a minor insulation terminal base, comprising a minor non-grounding terminal installation structure, wherein the minor non-grounding terminal installation structure provides the installation for the minor non-grounding conductive terminal, forming a minor non-grounding conductive terminal installation module; the conductive plastic base provides support for minor non-grounding conductive terminal installation module, forming a minor grounding conductive terminal installation module, and the minor grounding conductive terminal installation module comprises a minor first grounding terminal installation structure and a minor second grounding terminal installation structure, wherein the minor first grounding terminal installation structure provides the installation for the minor first grounding conductive terminal, and the minor second grounding terminal installation structure provides the installation for the minor second grounding conductive terminal, positioning the minor non-grounding conductive terminal between the minor first grounding conductive terminal and the minor second grounding conductive terminal, within the minor grounding conductive terminal installation module, the minor first conductive plastic wall structure abuts against the minor first grounding conductive terminal, and the minor second conductive plastic wall structure abuts against the minor second grounding conductive terminal, enabling the conductive plastic base to electrically connect the minor first grounding conductive terminal and the minor second grounding conductive terminal, allowing the minor conductive plastic base body, the minor first conductive plastic wall structure, the minor second conductive plastic wall structure, the minor first grounding conductive terminal, and the minor second grounding conductive terminal together form a minor non-grounding terminal shielding wall, and the minor non-grounding terminal shielding wall comprises a U-shaped cross-section, allowing the minor non-grounding terminal shielding wall to provide shielding wall on at least three sides of the minor non-grounding conductive terminal.

Preferably, the electrical connector said above, wherein the front end of the electrical connector is an electrical connector front end, and the electrical connector comprises a minor front conductive connecting body, and the minor front conductive connecting body extends at the electrical connector front end and spans over the minor non-grounding conductive terminal, electrically connecting to the minor first grounding conductive terminal and the minor second grounding conductive terminal, enabling the minor front conductive connecting body to electrically connect to the minor non-grounding terminal shielding wall and to provide the electrical shielding to the minor non-grounding conductive terminal at the electrical connector front end, wherein the minor first grounding conductive terminal comprises a minor first grounding terminal front joining structure, the minor second grounding conductive terminal comprises a minor second grounding terminal front joining structure, and the minor non-grounding conductive terminal comprises a minor non-grounding terminal front joining structure, additionally, the minor first grounding terminal front joining structure, the minor second grounding terminal front joining structure, and the minor non-grounding terminal front joining structure are located at the electrical connector front end.

Preferably, the electrical connector said above, wherein the minor front conductive connecting body comprises a minor front wall shielding structure, and the minor front wall shielding structure is provided at the electrical connector front end to serve as a shielding wall for the minor non-grounding conductive terminal.

Preferably, the electrical connector said above, wherein the minor front conductive connecting body comprises a minor front connector hollow structure, and the minor front connector hollow structure is hollowed out at the electrical connector front end to provide impedance matching for the minor non-grounding conductive terminal.

Preferably, the electrical connector said above, wherein the minor conductive plastic base body extends around one side of the minor non-grounding conductive terminal.

Preferably, the electrical connector said above, wherein the minor first grounding conductive terminal and the minor second grounding conductive terminal are respectively inserted into the minor first conductive plastic wall structure and the minor second conductive plastic wall structure, allowing the minor first grounding conductive terminal and the minor second grounding conductive terminal to electrically connect to the conductive plastic base.

Preferably, the electrical connector said above, wherein the minor first conductive plastic wall structure and the minor second conductive plastic wall structure respectively enter the minor insulation terminal base, enabling to individually abut against the minor first grounding conductive terminal and the minor second grounding conductive terminal.

Preferably, the electrical connector said above, wherein the minor first conductive plastic wall structure and the minor second conductive plastic wall structure individually abut against the minor first grounding conductive terminal and the minor second grounding conductive terminal in surface contact, providing structural support for the minor first grounding conductive terminal and the minor second grounding conductive terminal respectively.

Preferably, the electrical connector said above, wherein the major insulation terminal base and the minor insulation terminal base can be formed separately or integrally.

Preferably, the electrical connector said above, wherein the major conductive plastic base body and the minor conductive plastic base body can be formed separately or integrally.

Additionally, this application also provides an electrical connector wherein one side of the electrical connector is an electrical connector major side, comprising: a major conductive terminal assembly, located on the electrical connector major side, comprising a major first grounding conductive terminal, a major second grounding conductive terminal, a major third grounding conductive terminal, a major first non-grounding conductive terminal and a major second non-grounding conductive terminal; a major first insulation non-grounding terminal base, comprising a major first non-grounding terminal installation structure, wherein the major first non-grounding terminal installation structure provides for the installation of the major first non-grounding conductive terminal to form a major first non-grounding conductive terminal installation module; a major second insulation non-grounding terminal base, comprising a major second non-grounding terminal installation structure, wherein the major second non-grounding terminal installation structure provides for the installation of the major second non-grounding conductive terminal to form a major second non-grounding conductive terminal installation module; and a conductive plastic base for supporting the major first non-grounding conductive terminal installation module and the major second non-grounding conductive terminal installation module to form a major grounding conductive terminal installation module, and the conductive plastic base comprises a major conductive plastic base body, a major first conductive plastic wall structure, a major second conductive plastic wall structure, and a major third grounding terminal wall structure, and the major conductive plastic base body electrically connects to the major first conductive plastic wall structure, the major second conductive plastic wall structure, and the major third grounding terminal wall structure, and the major grounding conductive terminal installation module comprises a major first grounding terminal installation structure, a major second grounding terminal installation structure, and a major third grounding terminal installation structure, wherein the major first grounding terminal installation structure is provided for installing the major first grounding conductive terminal, the major second grounding terminal installation structure is provided for installing the major second grounding conductive terminal, and the major third grounding terminal installation structure is provided for installing the major third grounding conductive terminal, allowing the major first non-grounding conductive terminal to be positioned between the major first grounding conductive terminal and the major second grounding conductive terminal and allowing the major second non-grounding conductive terminal to be positioned between the major second grounding conductive terminal and the major third grounding conductive terminal, in the major grounding conductive terminal installation module, the major first conductive plastic wall structure is abutted against the major first grounding conductive terminal, the major second conductive plastic wall structure is abutted against the major second grounding conductive terminal, and the major third grounding terminal wall structure is abutted against the major third grounding conductive terminal to allow the conductive plastic base to electrically connect to the major first grounding conductive terminal, the major second grounding conductive terminal, and the major third grounding conductive terminal, enabling the major conductive plastic base body, the major first conductive plastic wall structure, the major second conductive plastic wall structure, the major first grounding conductive terminal, and the major second grounding conductive terminal to form a major first non-grounding terminal shielding wall, and the major first non-grounding terminal shielding wall comprises a U-shaped cross-section, allowing the major first non-grounding terminal shielding wall to provide a shielding wall on at least three sides of the major first non-grounding conductive terminal, further enabling the major conductive plastic base body, the major second conductive plastic wall structure, the major third grounding terminal wall structure, the major second grounding conductive terminal, and the major third grounding conductive terminal to form a major second non-grounding terminal shielding wall, and the major second non-grounding terminal shielding wall comprises a U-shaped cross-section, allowing the major second non-grounding terminal shielding wall to provide a shielding wall on at least three sides of the major second non-grounding conductive terminal.

Preferably, the electrical connector said above, wherein the front end of the electrical connector is an electrical connector front end, and the electrical connector further comprises a major front conductive connecting body, wherein the major front conductive connecting body extends at the electrical connector front end and spans over the major first non-grounding conductive terminal and the major second non-grounding conductive terminal, electrically connecting to the major first grounding conductive terminal, the major second grounding conductive terminal, and the major third grounding conductive terminal, enabling the major front conductive connecting body to electrically connect to the major first non-grounding terminal shielding wall, thereby providing electrical shielding to the major first non-grounding conductive terminal at the electrical connector front end, further enabling the major front conductive connecting body to electrically connect to the major second non-grounding terminal shielding wall, thereby providing electrical shielding to the major second non-grounding conductive terminal at the electrical connector front end, wherein the major first grounding conductive terminal comprises a major first grounding terminal front joining structure, the major second grounding conductive terminal comprises a major second grounding terminal front joining structure, the major third grounding conductive terminal comprises a major third grounding terminal front joining structure, the major third grounding conductive terminal comprises a major third grounding terminal front joining structure, the major first non-grounding conductive terminal comprises a major first non-grounding terminal front joining structure, and the major second non-grounding conductive terminal comprises a major second non-grounding terminal front joining structure, additionally, the major first grounding terminal front joining structure, the major second grounding terminal front joining structure, the major third grounding terminal front joining structure, the major first non-grounding terminal front joining structure, and the major second non-grounding terminal front joining structure are respectively located at the electrical connector front end.

Preferably, the electrical connector said above, wherein the major front conductive connector comprises a major front wall shielding structure, and the major front wall shielding structure provides a shielding wall for the major first non-grounding conductive terminal or the major second non-grounding conductive terminal at the electrical connector front end.

Preferably, the electrical connector said above, wherein the major front conductive connector comprises a major front connector hollow structure, and the major front connector hollow structure is hollowed out at the electrical connector front end to provide impedance matching for the major first non-grounding conductive terminal and the major second non-grounding conductive terminal.

Preferably, the electrical connector said above, wherein the major conductive plastic base body extends around one side of the major first non-grounding conductive terminal and the major second non-grounding conductive terminal.

Preferably, the electrical connector said above, wherein the major first grounding conductive terminal is inserted into the major first conductive plastic wall structure, the major second grounding conductive terminal is inserted into the major second conductive plastic wall structure, and the major third grounding conductive terminal is inserted into the major third grounding terminal wall structure, allowing the major first grounding conductive terminal, the major second grounding conductive terminal, and the major third grounding conductive terminal to electrically connect to the conductive plastic base.

Preferably, the electrical connector said above, wherein the major first conductive plastic wall structure abuts against the major first grounding conductive terminal in surface contact, the major second conductive plastic wall structure abuts against the major second grounding conductive terminal in surface contact, and the major third grounding terminal wall structure abuts against the major third grounding conductive terminal in surface contact, providing structural support for the major first grounding conductive terminal, the major second grounding conductive terminal, and the major third grounding conductive terminal respectively.

Preferably, the electrical connector said above, wherein the other side of the electrical connector is an electrical connector minor side, wherein the conductive plastic base also comprises a minor conductive plastic base body, a minor first conductive plastic wall structure, and a minor second conductive plastic wall structure, and a minor third grounding terminal wall structure, and the minor conductive plastic base body electrically connects to the minor first conductive plastic wall structure and the minor second conductive plastic wall structure, and the minor third grounding terminal wall structure, and the electrical connector further comprises: a minor conductive terminal assembly, located on the electrical connector minor side, comprising a minor first grounding conductive terminal, a minor second grounding conductive terminal, a minor third grounding conductive terminal, a minor first non-grounding conductive terminal, and a minor second non-grounding conductive terminal; a minor first insulation non-grounding terminal base, comprising a minor first non-grounding terminal installation structure, wherein the minor first non-grounding terminal installation structure provides the installation for the minor first non-grounding conductive terminal, forming a minor first non-grounding conductive terminal installation module; a minor second insulation non-grounding terminal base, comprising a minor second non-grounding terminal installation structure, wherein the minor second non-grounding terminal installation structure provides the installation for the minor second non-grounding conductive terminal, forming a minor second non-grounding conductive terminal installation module; wherein the conductive plastic base provides support for the minor first non-grounding conductive terminal installation module and the minor second non-grounding conductive terminal installation module, forming a minor grounding conductive terminal installation module, and the minor grounding conductive terminal installation module comprises a minor first grounding terminal installation structure, a minor second grounding terminal installation structure, and a minor third grounding terminal installation structure, wherein the minor first grounding terminal installation structure provides the installation for the minor first grounding conductive terminal, the minor second grounding terminal installation structure provides the installation for the minor second grounding conductive terminal, and the minor third grounding terminal installation structure provides the installation for the minor third grounding conductive terminal, positioning the minor first non-grounding conductive terminal between the minor first grounding conductive terminal and the minor second grounding conductive terminal, further positioning the minor second non-grounding conductive terminal between the minor second grounding conductive terminal and the minor third grounding conductive terminal, within the minor grounding conductive terminal installation module, the minor first conductive plastic wall structure abuts against the minor first grounding conductive terminal, the minor second conductive plastic wall structure abuts against the minor second grounding conductive terminal, and the minor third grounding terminal wall structure abuts against the minor third grounding conductive terminal, enabling the conductive plastic base to electrically connect to the minor first grounding conductive terminal, the minor second grounding conductive terminal, and the minor third grounding conductive terminal, allowing the minor conductive plastic base body, the minor first conductive plastic wall structure, the minor second conductive plastic wall structure, the minor first grounding conductive terminal, and the minor second grounding conductive terminal together form a minor first non-grounding terminal shielding wall, and the minor first non-grounding terminal shielding wall comprises a U-shaped cross-section, allowing the minor first non-grounding terminal shielding wall to provide a shielding wall on at least three sides of the minor first non-grounding conductive terminal, further allowing the minor conductive plastic base body, the minor second conductive plastic wall structure, the minor third grounding terminal wall structure, the minor second grounding conductive terminal, and the minor third grounding conductive terminal together form a minor second non-grounding terminal shielding wall, and the minor second non-grounding terminal shielding wall comprises a U-shaped cross-section, allowing the minor second non-grounding terminal shielding wall to provide a shielding wall on at least three sides of the minor second non-grounding conductive terminal.

Preferably, the electrical connector said above, wherein the front end of the electrical connector is an electrical connector front end, and the electrical connector comprises a minor front conductive connecting body, and the minor front conductive connecting body extends at the electrical connector front end and spans over the minor first non-grounding conductive terminal and the minor second non-grounding conductive terminal, electrically connecting to the minor first grounding conductive terminal, the minor second grounding conductive terminal, and the minor third grounding conductive terminal, enabling the minor front conductive connecting body to electrically connect to the minor first non-grounding terminal shielding wall to provide the electrical shielding to the minor first non-grounding conductive terminal at the electrical connector front end, further enabling the minor front conductive connecting body to electrically connect to the minor second non-grounding terminal shielding wall to provide the electrical shielding to the minor second non-grounding conductive terminal at the electrical connector front end, wherein the minor first grounding conductive terminal comprises a minor first grounding terminal front joining structure, the minor second grounding conductive terminal comprises a minor second grounding terminal front joining structure, the minor third grounding conductive terminal comprises a minor third grounding terminal front joining structure, the minor first non-grounding conductive terminal comprises a minor first non-grounding terminal front joining structure, and the minor second non-grounding conductive terminal comprises a minor second non-grounding terminal front joining structure, additionally, the minor first grounding terminal front joining structure, the minor second grounding terminal front joining structure, the minor third grounding terminal front joining structure, the minor first non-grounding terminal front joining structure, and the minor second non-grounding terminal front joining structure are respectively located at the electrical connector front end.

Preferably, the electrical connector said above, wherein the minor front conductive connecting body comprises a minor front wall shielding structure, and the minor front wall shielding structure is provided at the electrical connector front end to serve as a shielding wall for the minor first non-grounding conductive terminal or the minor second non-grounding conductive terminal.

Preferably, the electrical connector said above, wherein the minor front conductive connecting body comprises a minor front connector hollow structure, and the minor front connector hollow structure is hollowed out at the electrical connector front end to provide impedance matching for the minor first non-grounding conductive terminal or the minor second non-grounding conductive terminal.

Preferably, the electrical connector said above, wherein the minor conductive plastic base body extends around one side of the minor first non-grounding conductive terminal and the minor second non-grounding conductive terminal.

Preferably, the electrical connector said above, wherein the minor first grounding conductive terminal is inserted into the minor first conductive plastic wall structure, the minor second grounding conductive terminal is inserted into the minor second conductive plastic wall structure, and the minor third grounding conductive terminal is inserted into the minor third grounding terminal wall structure, allowing the minor first grounding conductive terminal, the minor second grounding conductive terminal, and the minor third grounding conductive terminal to electrically connect to the conductive plastic base.

Preferably, the electrical connector said above, wherein the minor first conductive plastic wall structure abuts against the minor first grounding conductive terminal in surface contact, the minor second conductive plastic wall structure abuts against the minor second grounding conductive terminal in surface contact, and the minor third grounding terminal wall structure abuts against the minor third grounding conductive terminal in surface contact, providing structural support for the minor first grounding conductive terminal, the minor second grounding conductive terminal, and the minor third grounding conductive terminal respectively.

Preferably, the electrical connector said above, wherein the major conductive plastic base body and the minor conductive plastic base body can be formed separately or integrally.

In comparison to prior art, an electrical connector provided in this application can provide a shielding wall to transmit shielded signals for at least three sides of the non-grounding conductive terminal, thereby effectively reducing interference when transmitting high-speed signals, and optimizing the transmission quality of the electrical connector for high-speed signals to meet the specific requirements and advancements of electronic devices.

### BRIEF DESCRIPTION OF THE DRAWINGS

The above and other aspects, comprises and other advantages of the present invention will be more clearly understood from the following detailed description taken in conjunction with the accompanying drawings, in which:

FIG. 1 is a three-dimensional schematic diagram of the electrical connector of the present application from a first perspective in an embodiment.

FIG. 2 is a three-dimensional schematic diagram of the electrical connector of the present application from a second perspective in an embodiment.

FIG. 3 is a top view schematic diagram of the electrical connector of the present application in an embodiment.

FIG. 4 is a sectional schematic diagram of some components of the electrical connector shown in FIG. 3 cut along the line AA.

FIG. 5 is a sectional schematic diagram of some components of the electrical connector shown in FIG. 3 cut along the line BB.

FIG. 6 is a sectional schematic diagram of some components of the electrical connector shown in FIG. 3 cut along the line CC.

FIG. 7 is a three-dimensional schematic diagram of some components of the electrical connector according to the present application from a first perspective in an embodiment.

FIG. 8 is a three-dimensional schematic diagram of some components of the electrical connector according to the present application from a second perspective in an embodiment.

FIG. 9 is a three-dimensional schematic diagram of some components of the electrical connector according to the present application from a first perspective in an embodiment.

FIG. 10 is a three-dimensional schematic diagram of some components of the electrical connector according to the present application from a second perspective in an embodiment.

FIG. 11 is a three-dimensional schematic diagram of some components of the electrical connector according to the present application from a first perspective in an embodiment.

FIG. 12 is a three-dimensional schematic diagram of some components of the electrical connector according to the present application from a second perspective in an embodiment.

FIG. 13 is a three-dimensional schematic diagram of some components of the electrical connector according to the present application from a first perspective in an embodiment.

FIG. 14 is a three-dimensional schematic diagram of some components of the electrical connector according to the present application from a second perspective in an embodiment.

FIG. 15 is a three-dimensional schematic diagram of some components of the electrical connector according to the present application from a first perspective in an embodiment.

FIG. 16 is a three-dimensional schematic diagram of some components of the electrical connector according to the present application from a second perspective in an embodiment.

FIG. 17 is a three-dimensional schematic diagram of some components of the electrical connector according to the present application in an embodiment.

FIG. 18 is a three-dimensional schematic diagram of some components of the electrical connector according to the present application in an embodiment.

FIG. 19 is a three-dimensional schematic diagram of the electrical connector of the present application from a first perspective in an embodiment.

FIG. 20 is a three-dimensional schematic diagram of the electrical connector of the present application from a second perspective in an embodiment.

FIG. 21 is a top view schematic diagram of the electrical connector of the present application in an embodiment.

FIG. 22 is a sectional schematic diagram of some components of the electrical connector shown in FIG. 21 cut along the line AA.

FIG. 23 is a sectional schematic diagram of some components of the electrical connector shown in FIG. 21 cut along the line BB.

FIG. 24 is a sectional schematic diagram of some components of the electrical connector shown in FIG. 21 cut along the line CC.

FIG. 25 is a three-dimensional schematic diagram of some components of the electrical connector according to the present application from a first perspective in an embodiment.

FIG. 26 is a three-dimensional schematic diagram of some components of the electrical connector according to the present application from a second perspective in an embodiment.

FIG. 27 is a three-dimensional schematic diagram of some components of the electrical connector according to the present application from a first perspective in an embodiment.

FIG. 28 is a three-dimensional schematic diagram of some components of the electrical connector according to the present application from a second perspective in an embodiment.

FIG. 29 is a three-dimensional schematic diagram of some components of the electrical connector according to the present application from a first perspective in an embodiment.

FIG. 30 is a three-dimensional schematic diagram of some components of the electrical connector according to the present application from a second perspective in an embodiment.

FIG. 31 is a three-dimensional schematic diagram of some components of the electrical connector according to the present application from a first perspective in an embodiment.

FIG. 32 is a three-dimensional schematic diagram of some components of the electrical connector according to the present application from a second perspective in an embodiment.

FIG. 33 is a three-dimensional schematic diagram of some components of the electrical connector according to the present application from a first perspective in an embodiment.

FIG. 34 is a three-dimensional schematic diagram of some components of the electrical connector according to the present application from a second perspective in an embodiment.

FIG. 35 is a three-dimensional schematic diagram of some components of the electrical connector according to the present application in an embodiment.

FIG. 36 is a three-dimensional schematic diagram of some components of the electrical connector according to the present application in an embodiment.

### DETAILED DESCRIPTION OF THE PREFERRED

### Embodiment

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

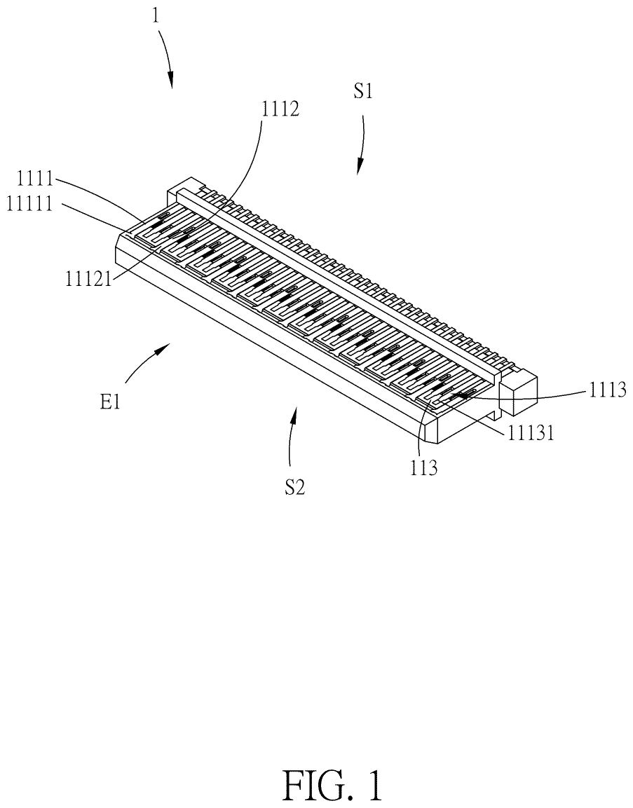

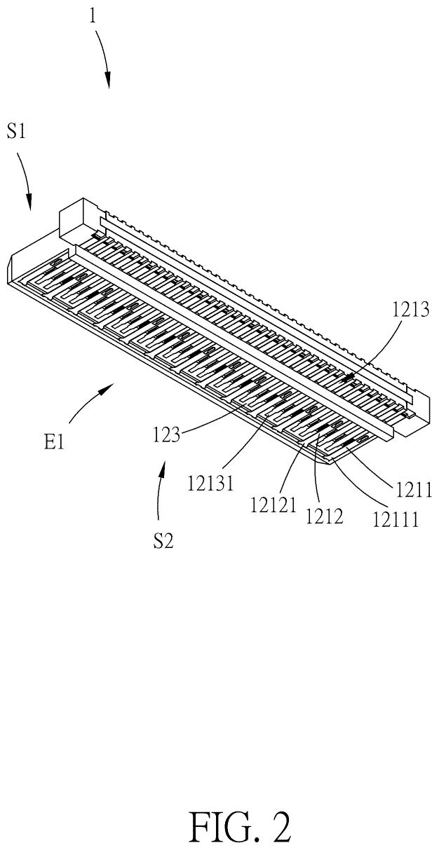

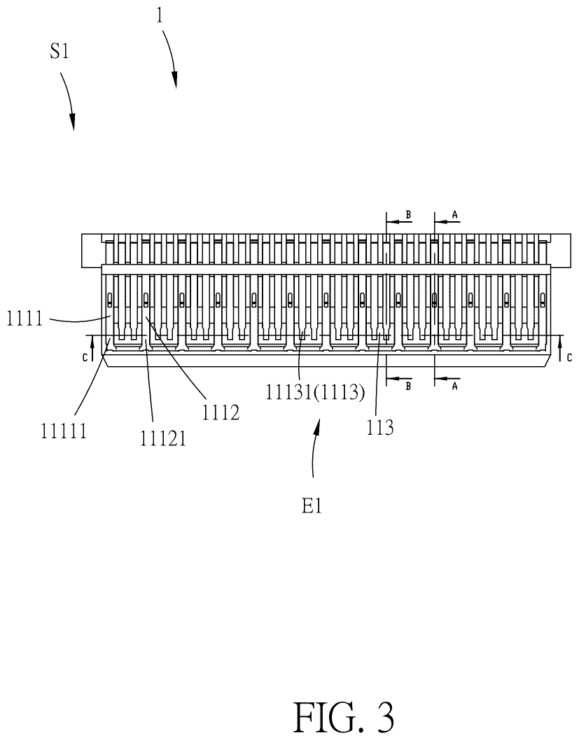

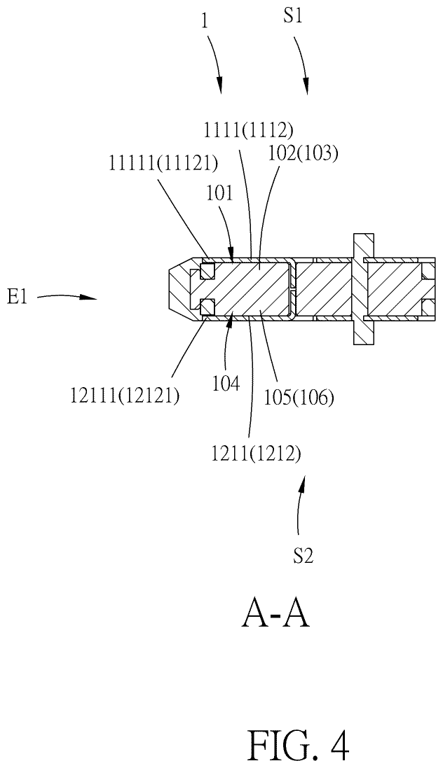

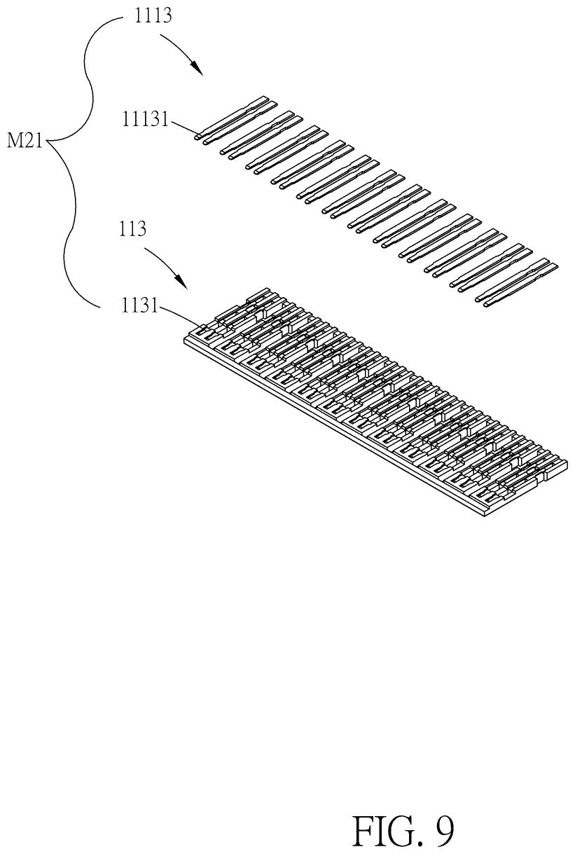

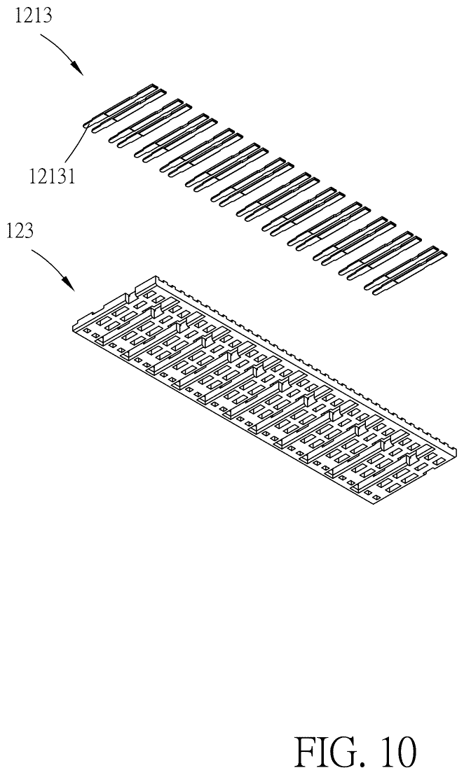

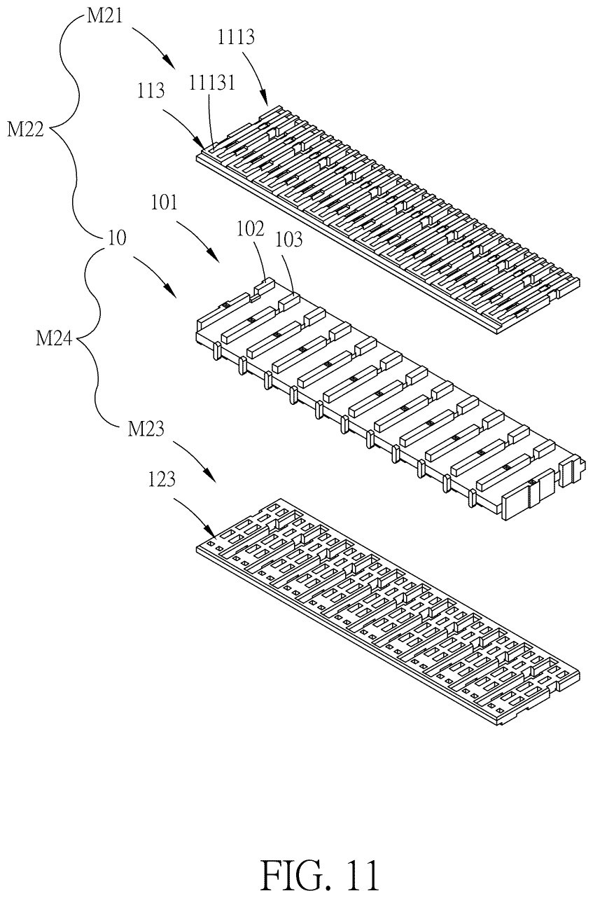

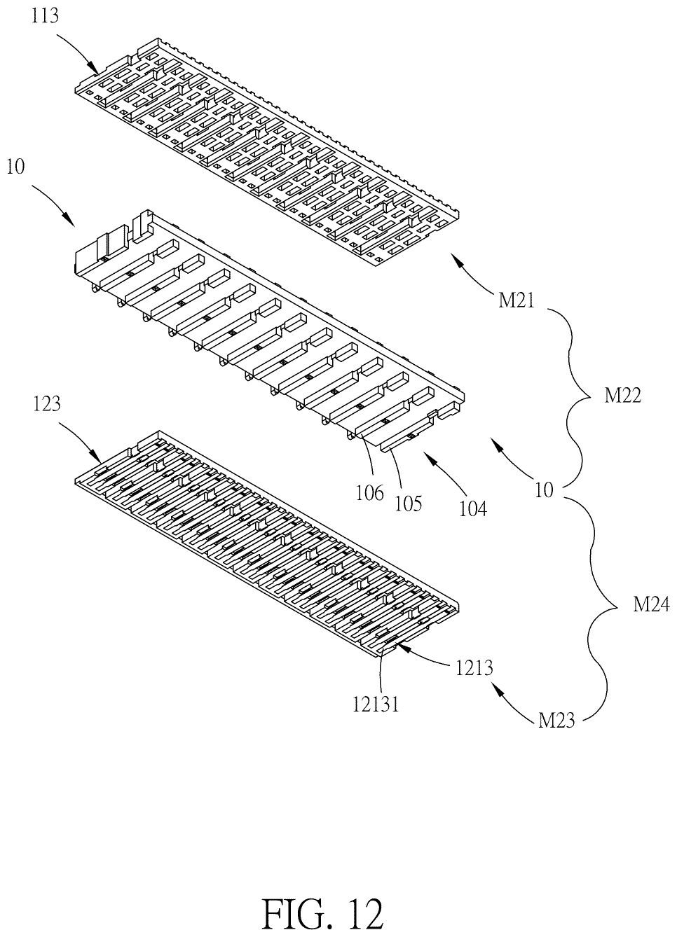

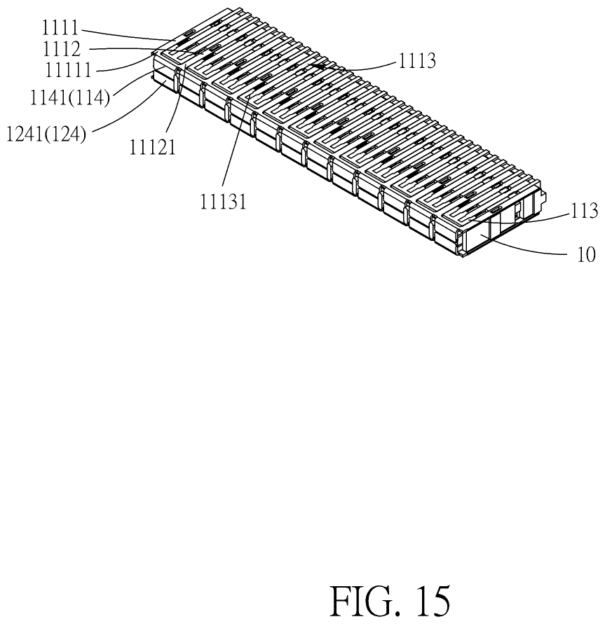

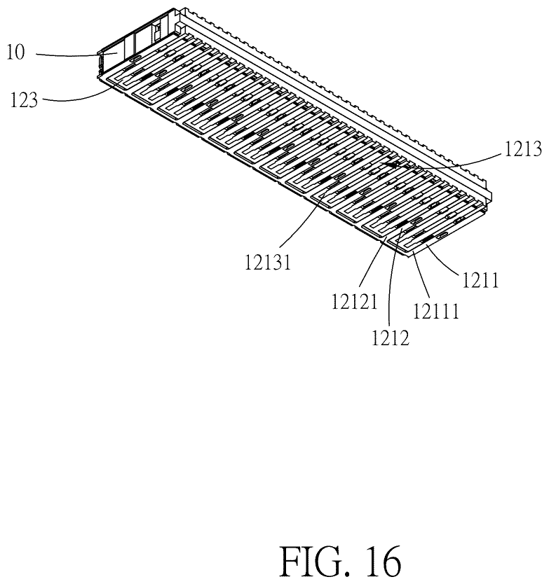

For a detailed description of the embodiments disclosed in the present application, please refer to FIGS. 1 to 18.

In the above embodiment, provided is an electrical connector 1 that can be installed in electronic devices. In the electronic devices, the electrical connector 1 can be respectively connected to a front-end conductive component to transmit signals. Additionally, the electrical connector 1 is respectively defined on both sides as an electrical connector major side S1 and an electrical connector minor side S2, and the front end of the electrical connector 1 defined as an electrical connector front end E1.

It should be noted that in the above embodiment, the electrical connector 1 can join to the front-end conductive component on the electrical connector major side S1, the electrical connector minor side S2 and the electrical connector front end E1.

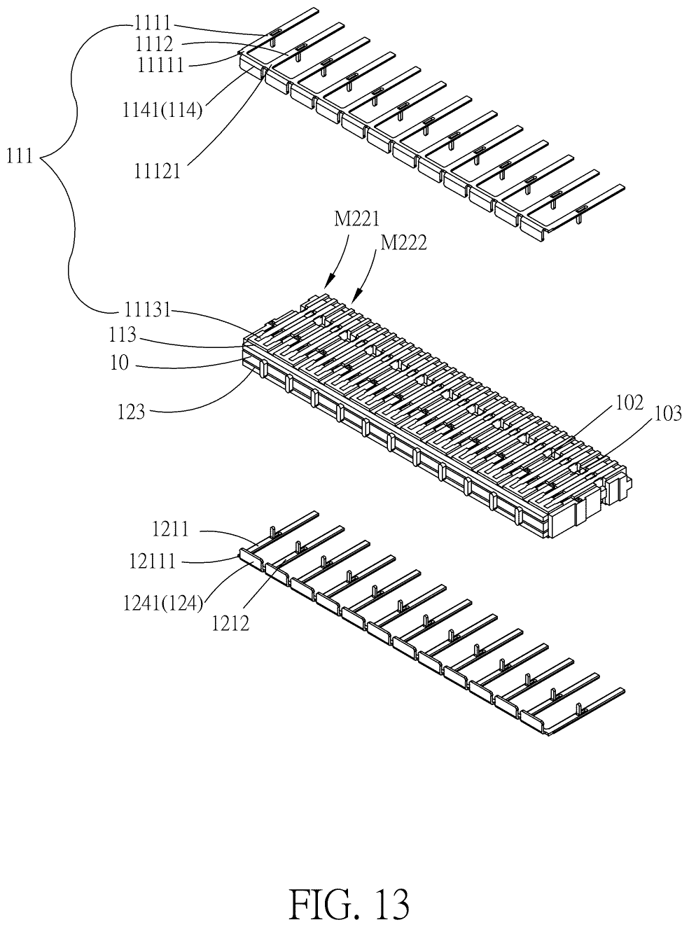

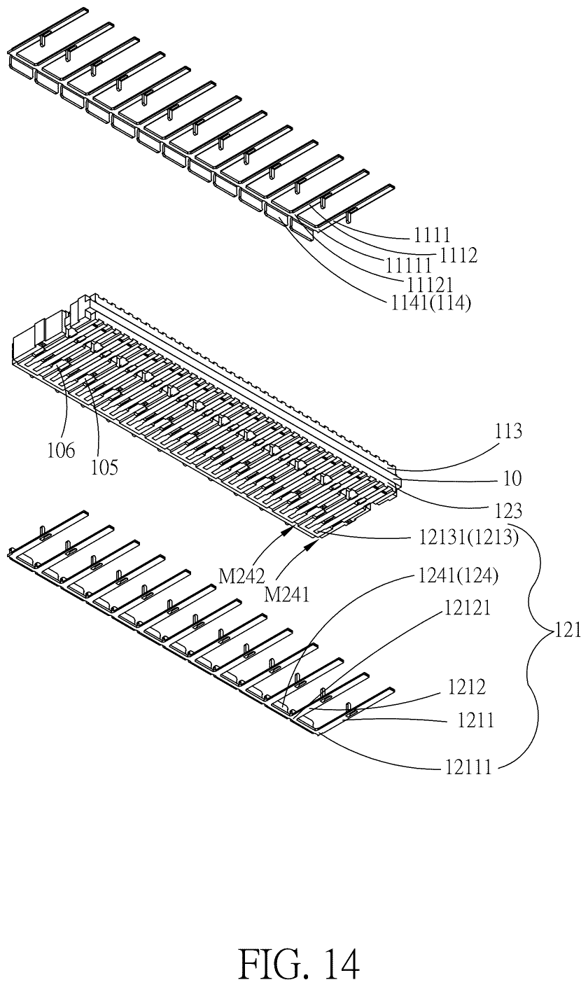

In the embodiments shown in FIGS. 13 to 14, the electrical connector 1 comprises: a conductive plastic base 10, a major conductive terminal assembly 111, a minor conductive terminal assembly 121, a major insulation terminal base 113, a minor insulation terminal base 123, a major front conductive connecting body 114, and a minor front conductive connecting body 124.

It should be noted that the conductive plastic base 10 can be made of conductive plastic material, capable of providing to transmit shielded signals such as ground signals. The major insulation terminal base 113 and the minor insulation terminal base 123 can be made of insulating material, providing positioning for the major conductive terminal assembly 111 and the minor conductive terminal assembly 121, respectively.

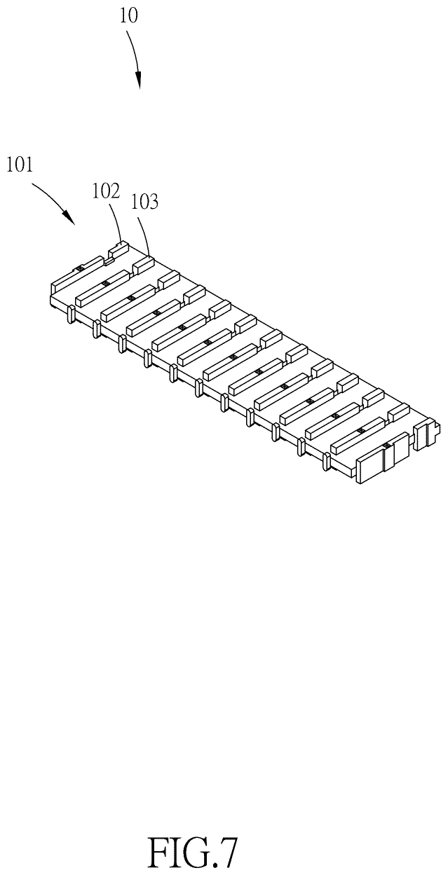

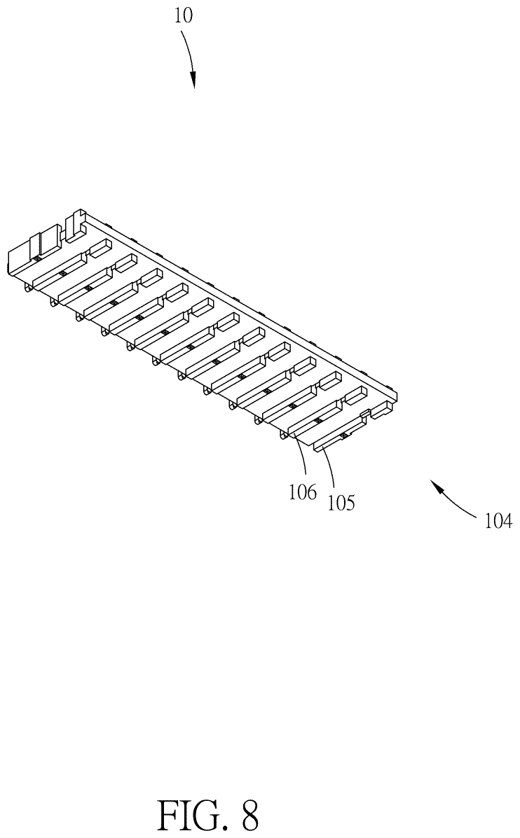

As shown in FIGS. 7 to 8, the conductive plastic base 10 comprises a major conductive plastic base body 101, a major first conductive plastic wall structure 102, a major second conductive plastic wall structure 103, a minor conductive plastic base body 104, a minor first conductive plastic wall structure 105, and a minor second conductive plastic wall structure 106.

It should be noted that, in this application, the major insulation terminal base 113 and the minor insulation terminal base 123 can be optionally formed separately or integrally. Similarly, the major conductive plastic base body 101 and the minor conductive plastic base body 104 can also be optionally formed separately or integrally.

As shown in FIGS. 1 to 3, the major conductive terminal assembly 111 is located on the electrical connector major side S1 and consists of a major first grounding conductive terminal 1111, a major second grounding conductive terminal 1112, and a major non-grounding conductive terminal 1113. The minor conductive terminal assembly 121 is located on the electrical connector minor side S2 and consists of a minor first grounding conductive terminal 1211, a minor second grounding conductive terminal 1212, and a minor non-grounding conductive terminal 1213.

It should be noted that the major first grounding conductive terminal 1111, the major second grounding conductive terminal 1112, the minor first grounding conductive terminal 1211, and the minor second grounding conductive terminal 1212 can provide transmission of grounding signals, and the number of the major first grounding conductive terminal 1111, the major second grounding conductive terminal 1112, the minor first grounding conductive terminal 1211, and the minor second grounding conductive terminal 1212 is not limited to one. The major non-grounding conductive terminal 1113 and the minor non-grounding conductive terminal 1213 can provide transmission of non-grounding signals, such as differential signals, and the number of the major non-grounding conductive terminal 1113 and the minor non-grounding conductive terminal 1213 is not limited to one.

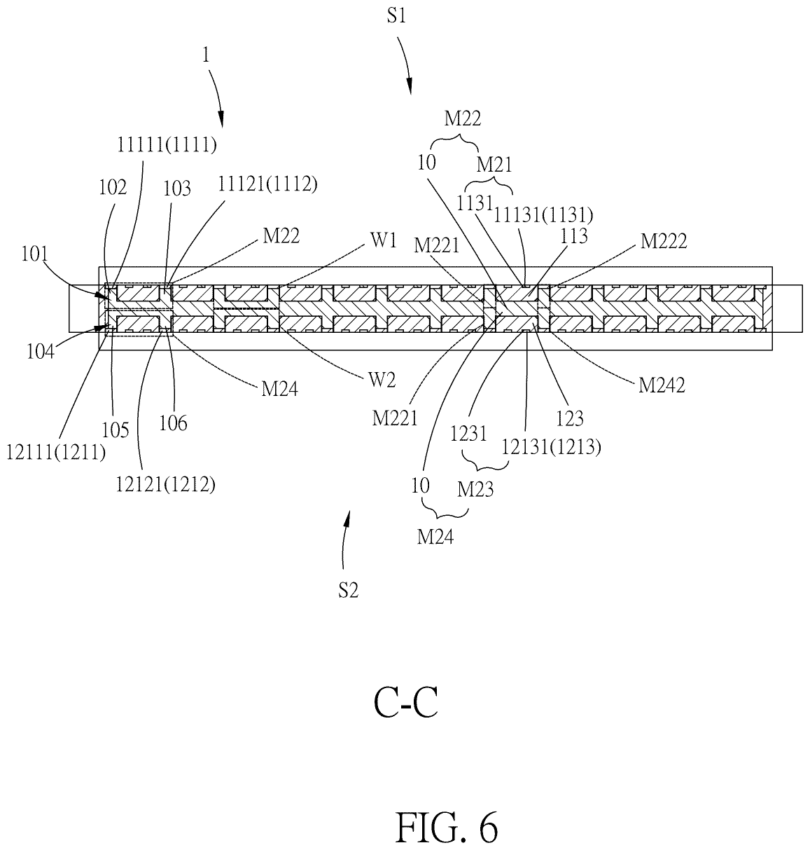

In the embodiments shown in FIGS. 6 and 11 to 12, the major insulation terminal base 113 comprises a major non-grounding terminal installation structure 1131, wherein the major non-grounding terminal installation structure 1131 is provided to install the major non-grounding conductive terminal 1113 to form a major non-grounding conductive terminal installation module M21. The conductive plastic base 10 provides support for the major non-grounding conductive terminal installation module M21 to form a major grounding conductive terminal installation module M33.

It should be noted that the major grounding conductive terminal installation module M33 comprises a major first grounding terminal installation structure M221 and a major second grounding terminal installation structure M222. The major first grounding terminal installation structure M221 is provided to install the major first grounding conductive terminal 1111, and the major second grounding terminal installation structure M222 is provided to install the major second grounding conductive terminal 1112, allowing the major non-grounding conductive terminal 1113 to be positioned between the major first grounding conductive terminal 1111 and the major second grounding conductive terminal 1112.

In the major grounding conductive terminal installation module M33, the major first conductive plastic wall structure 102 is abutted against the major first grounding conductive terminal 1111, and the major second conductive plastic wall structure 103 is abutted against the major second grounding conductive terminal 1112, allowing the conductive plastic base 10 to electrically connect to the major first grounding conductive terminal 1111 and the major second grounding conductive terminal 1112, enabling the major conductive plastic base body 101, the major first conductive plastic wall structure 102, the major second conductive plastic wall structure 103, the major first grounding conductive terminal 1111, and the major second grounding conductive terminal 1112 to form a major non-grounding terminal shielding wall W1. The major non-grounding terminal shielding wall W1 can provide shielding signals, such as ground signals, and comprises a U-shaped cross-section, enabling the major non-grounding terminal shielding wall W1 to provide shielding wall on at least three sides of the major non-grounding conductive terminal 1113, creating an electrically shielded environment for signal transmission, thereby reducing interference for the signal transmission of the major non-grounding conductive terminal 1113, optimizing the transmission quality of high-speed signals in the electrical connector 1, meeting the special requirements and development of electronic devices.

Preferably, the major first conductive plastic wall structure 102 abut to the major first grounding conductive terminal 1111 in the way such as surface contact, providing structural support to the major first grounding conductive terminal 1111, and the major second conductive plastic wall structure 103 abut to the major second grounding conductive terminal 1112 in the way such as surface contact, providing structural support to the major second grounding conductive terminal 1112, reducing the degree of deformation experienced by the major first grounding conductive terminal 1111 and the major second grounding conductive terminal 1112.

As shown in FIGS. 6, 11, and 17, the major conductive plastic base body 101 electrically connects to the major first conductive plastic wall structure 102 and the major second conductive plastic wall structure 103, enabling to provide transmission of shielding signals, such as grounding signals. Additionally, the major conductive plastic base body 101 extends around one side of the major non-grounding conductive terminal 1113, thereby providing an electrically shielded environment for signal transmission of the major non-grounding conductive terminal 1113.

Furthermore, as shown in FIGS. 6, 13, and 17, the major first grounding conductive terminal 1111 is inserted into the major first conductive plastic wall structure 102, and the major second grounding conductive terminal 1112 is inserted into the major second conductive plastic wall structure 103, allowing the major first grounding conductive terminal 1111 and the major second grounding conductive terminal 1112 to electrically connect to the conductive plastic base 10. As shown in FIGS. 6, 11, 13, and 17, the major first conductive plastic wall structure 102 and the major second conductive plastic wall structure 103 respectively enter the major insulation terminal base 113. The major first conductive plastic wall structure 102 can abut against the major first grounding conductive terminal 1111, and the major second conductive plastic wall structure 103 can abut against the major second grounding conductive terminal 1112.

The major first grounding conductive terminal 1111 comprises a major first grounding terminal front joining structure 11111, the major second grounding conductive terminal 1112 comprises a major second grounding terminal front joining structure 11121, and the major non-grounding conductive terminal 1113 comprises a major non-grounding terminal front joining structure 11131. The major first grounding terminal front joining structure 11111, the major second grounding terminal front joining structure 11121, and the major non-grounding terminal front joining structure 11131 can be respectively joined to the front-end conductive component at the electrical connector front end E1 to provide transmission of electrical signals.

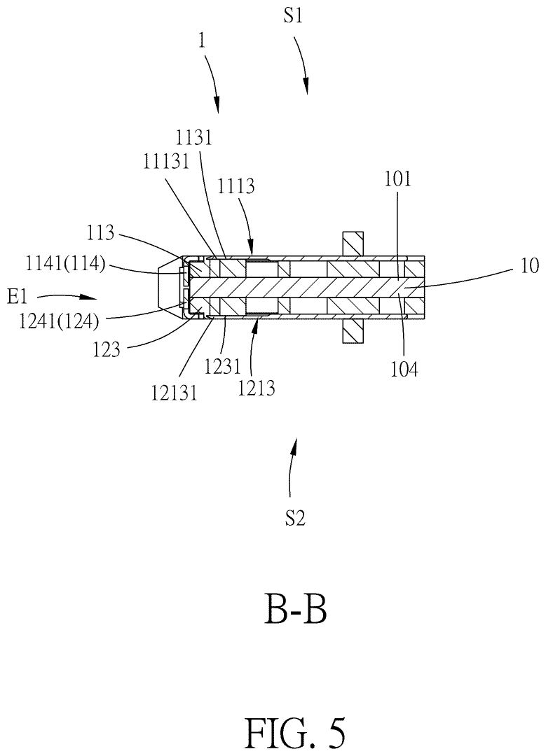

Additionally, as shown in FIGS. 5 and 6, the major front conductive connecting body 114 extends at the electrical connector front end E1 and spans over the major non-grounding conductive terminal 1113, and electrically connects to the major first grounding conductive terminal 1111 and the major second grounding conductive terminal 1112, allowing the major front conductive connecting body 114 to electrically connect to the major non-grounding terminal shielding wall W1, providing shielding wall to the major non-grounding conductive terminal 1113 at the electrical connector front end E1 to providing an electrical shielding environment for the signal transmission of the major non-grounding conductive terminal 1113, thereby reducing interference when transmitting high-speed signals, optimizing the transmission quality of the electrical connector 1 to meet the specific requirements and development of electronic devices.

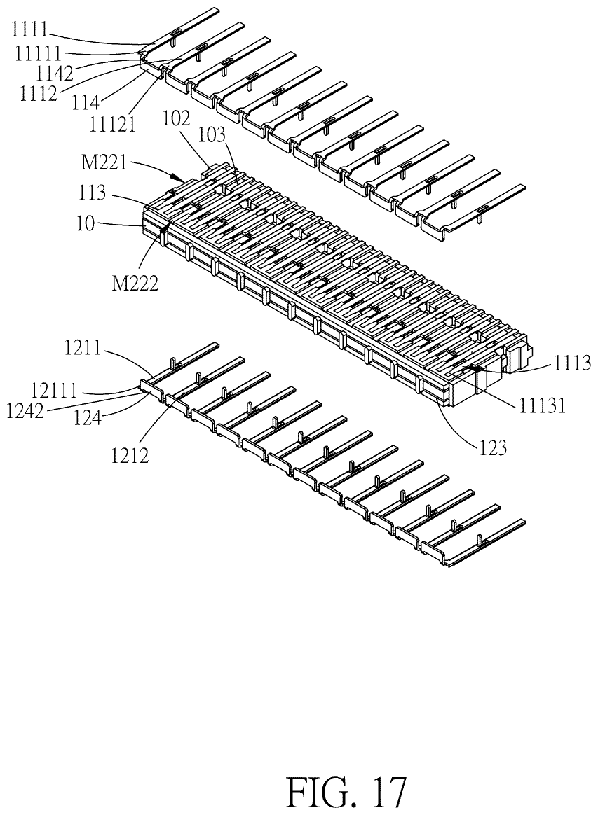

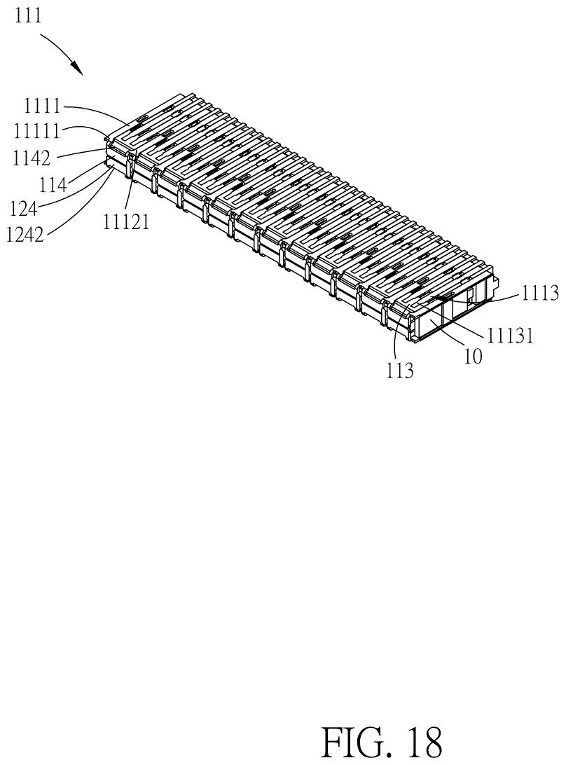

In the embodiments shown in FIGS. 5, 13, and 15, the major front conductive connecting body 114 comprises a major front wall shielding structure 1141, and the major front wall shielding structure 1141 provides a shielding wall for the major non-grounding conductive terminal 1113 at the electrical connector front end E1, providing an electrical shielding environment for signal transmission of the major non-grounding conductive terminal 1113. However, this is not limiting. In the embodiments illustrated in FIGS. 17 to 18, the major front conductive connecting body 114 comprises a major front connector hollow structure 1142, and the major front connector hollow structure 1142 provides impedance matching for the major non-grounding conductive terminal 1113 at the electrical connector front end E1.

In the embodiments shown in FIGS. 6 and 11 to 12, the minor insulation terminal base 123 comprises a minor non-grounding terminal installation structure 1231, wherein the minor non-grounding terminal installation structure 1231 is provided for installing the minor non-grounding conductive terminal 1213, thereby forming a minor non-grounding conductive terminal installation module M23. The conductive plastic base 10 provides support for the minor non-grounding conductive terminal installation module M23, forming a minor grounding conductive terminal installation module M36.

It should be noted that the minor grounding conductive terminal installation module M36 comprises a minor first grounding terminal installation structure M361 and a minor second grounding terminal installation structure M362. The minor first grounding terminal installation structure M361 is provided for installing the minor first grounding conductive terminal 1211, and the minor second grounding terminal installation structure M362 is provided for installing the minor second grounding conductive terminal 1212, positioning the minor non-grounding conductive terminal 1213 between the minor first grounding conductive terminal 1211 and the minor second grounding conductive terminal 1212.

In the minor grounding conductive terminal installation module M36, the minor first conductive plastic wall structure 105 is abutted against the minor first grounding conductive terminal 1211, and the minor second conductive plastic wall structure 106 is abutted against the minor second grounding conductive terminal 1212, enabling the conductive plastic base 10 to electrically connect the minor first grounding conductive terminal 1211 and the minor second grounding conductive terminal 1212, allowing the conductive plastic base body 104, the minor first conductive plastic wall structure 105, the minor second conductive plastic wall structure 106, the minor first grounding conductive terminal 1211, and the minor second grounding conductive terminal 1212 to form a minor non-grounding terminal shielding wall W2. The minor non-grounding terminal shielding wall W2 can provide shielding signals such as ground signals and comprises a U-shaped cross-section, allowing the minor non-grounding terminal shielding wall W2 to provide a shielding wall on at least three sides of the minor non-grounding conductive terminal 1213 to create an electrically shielded environment for signal transmission of the minor non-grounding conductive terminal 1213, reducing interference during transmission of high-speed signals by the electrical connector 1, thereby enhancing the transmission quality of high-speed signals by the electrical connector 1, meeting the special requirements and development needs of electronic devices.

Optionally, the minor first conductive plastic wall structure 105 is abutted against the minor first grounding conductive terminal 1211 in surface contact to provide structural support for the minor first grounding conductive terminal 1211, reducing the degree of deformation experienced by the minor first grounding conductive terminal 1211. Similarly, the minor second conductive plastic wall structure 106 is abutted against the minor second grounding conductive terminal 1212 in surface contact to provide structural support for the minor second grounding conductive terminal 1212, thereby reducing the degree of deformation experienced by the minor second grounding conductive terminal 1212.

As shown in FIGS. 6, 12, and 14, the minor conductive plastic base body 104 electrically connects to the minor first conductive plastic wall structure 105 and the minor second conductive plastic wall structure 106, enabling to provide transmission of shielding signals, such as grounding signals. Additionally, the minor conductive plastic base body 104 extends around one side of the minor non-grounding conductive terminal 1213, thereby providing an electrically shielded environment for signal transmission of the minor non-grounding conductive terminal 1213

Additionally, as shown in FIGS. 6 and 14, the minor first grounding conductive terminal 1211 and the minor second grounding conductive terminal 1212 are respectively inserted into the minor first conductive plastic wall structure 105 and the minor second conductive plastic wall structure 106, enabling the minor first grounding conductive terminal 1211 and the minor second grounding conductive terminal 1212 to electrically connect to the conductive plastic base 10. As shown in FIGS. 14, the minor first conductive plastic wall structure 105 and the minor second conductive plastic wall structure 106 respectively enter the minor insulation terminal base 123, thereby enabling the minor first conductive plastic wall structure 105 to abut to the minor first grounding conductive terminal 1211, and enabling the minor second conductive plastic wall structure 106 to abut to the minor second grounding conductive terminal 1212.

The minor first grounding conductive terminal 1211 comprises a minor first grounding terminal front joining structure 12111. The minor second grounding conductive terminal 1212 comprises a minor second grounding terminal front joining structure 12121. The minor non-grounding conductive terminal 1213 comprises a minor non-grounding terminal front joining structure 12131. The minor first grounding terminal front joining structure 12111, the minor second grounding terminal front joining structure 12121, and the minor non-grounding terminal front joining structure 12131 can be respectively joined to the front-end conductive component at the electrical connector front end E1 to provide the transmission of electrical signals.

Additionally, as shown in FIGS. 5 to 6, and FIG. 14, the minor front conductive connecting body 124 extends at the electrical connector front end E1 and spans over the minor non-grounding conductive terminal 1213, and electrically connects to the minor first grounding conductive terminal 1211 and the minor second grounding conductive terminal 1212, allowing the minor front conductive connecting body 124 to connect to the minor non-grounding terminal shielding wall W2, providing electrically shielding to the minor non-grounding conductive terminal 1213 at the electrical connector front end E1 to providing an electrical shielding environment for the signal transmission of the minor non-grounding conductive terminal 1213, thereby reducing interference when transmitting high-speed signals, optimizing the transmission quality of the electrical connector 1 to meet the specific requirements and development of electronic devices.

In the embodiments shown in FIGS. 5 and 14, the minor front conductive connecting body 124 comprises a minor front wall shielding structure 1241, and the minor front wall shielding structure 1241 provides a shielding wall for the minor non-grounding conductive terminal 1213 at the electrical connector front end E1, providing an electrical shielding environment for signal transmission of the minor non-grounding conductive terminal 1213. However, this is not limiting. In the embodiments illustrated in FIGS. 17 to 18, the minor front conductive connecting body 124 comprises a minor front connector hollow structure 1242, and the minor front connector hollow structure 1242 provides impedance matching for the minor non-grounding conductive terminal 1213 at the electrical connector front end E1.

It should be noted that, in the embodiments described in the present application, certain components may be optionally omitted. For example, the electrical connector may selectively include: a major conductive terminal assembly, a major insulation terminal base, and a conductive plastic base. The major conductive terminal assembly is located on the electrical connector major side and comprises a major first grounding conductive terminal, a major second grounding conductive terminal, and a major non-grounding conductive terminal. The major insulation terminal base comprises a major non-grounding terminal installation structure, wherein the major non-grounding terminal installation structure provides for the installation of the major non-grounding conductive terminal to form a major non-grounding conductive terminal installation module. The conductive plastic base provides support for carrying the major non-grounding conductive terminal installation module to form a major grounding conductive terminal installation module. The conductive plastic base comprises a major conductive plastic base body, a major first conductive plastic wall structure, and a major second conductive plastic wall structure. The major conductive plastic base body electrically connects to the major first conductive plastic wall structure and the major second conductive plastic wall structure. The major grounding conductive terminal installation module comprises a major first grounding terminal installation structure and a major second grounding terminal installation structure, wherein the major grounding terminal installation structure is provided for the installation of the major first grounding conductive terminal, and the major second grounding terminal installation structure is provided for the installation of the major second grounding conductive terminal, allowing the major non-grounding conductive terminal is located between the major first grounding conductive terminal and the major second grounding conductive terminal. In the major grounding conductive terminal installation module, the major first conductive plastic wall structure is abutted against the major first grounding conductive terminal to provide structural support for the major first grounding conductive terminal, and the major second conductive plastic wall structure is abutted against the major second grounding conductive terminal to provide structural support for the major second grounding conductive terminal, allowing the conductive plastic base electrically connects to the major first grounding conductive terminal and the major second grounding conductive terminal, thereby enabling the major conductive plastic base body, the major first conductive plastic wall structure, the major second conductive plastic wall structure, the major first grounding conductive terminal, and the major second grounding conductive terminal to form a major non-grounding terminal shielding wall. The major non-grounding terminal shielding wall comprises a U-shaped cross-section and provides shielding walls on at least three sides of the major non-grounding conductive terminal.

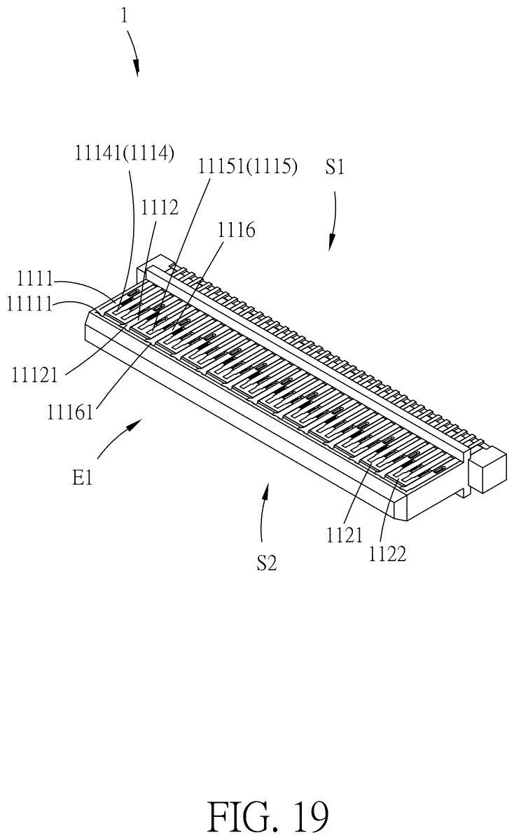

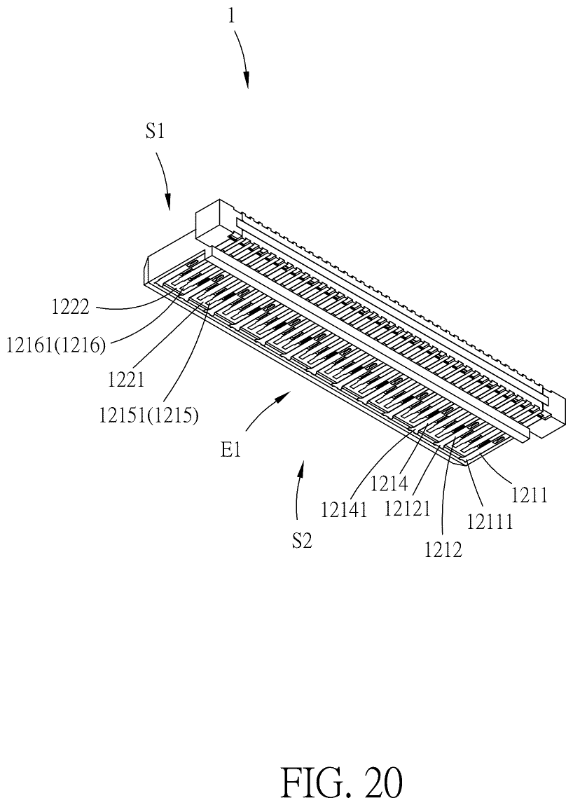

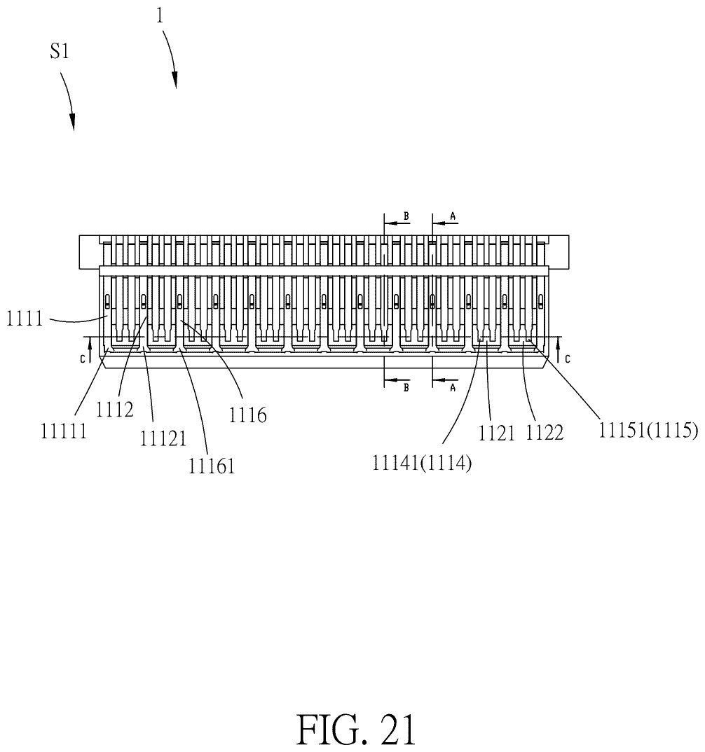

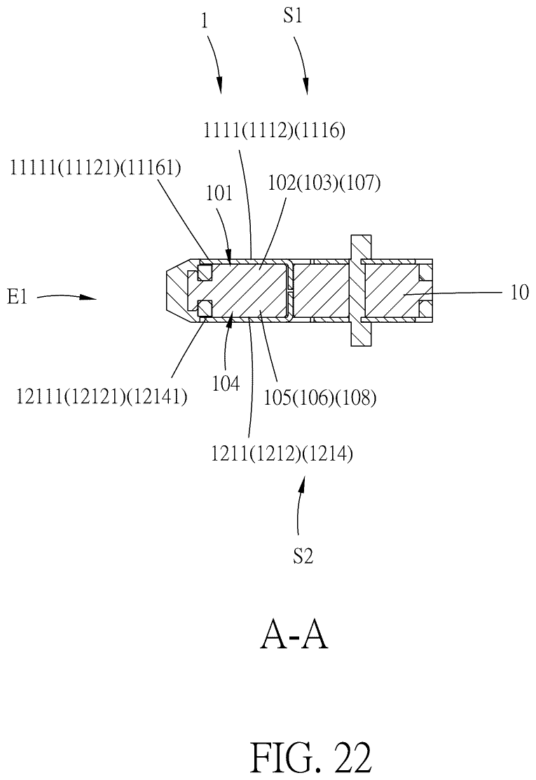

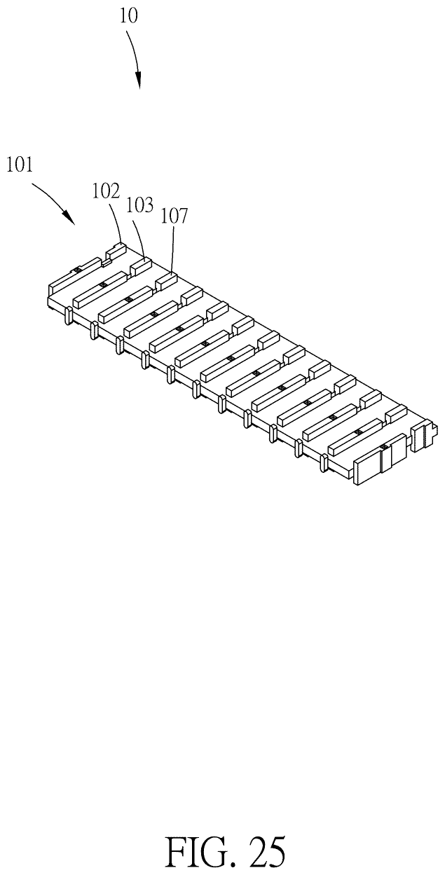

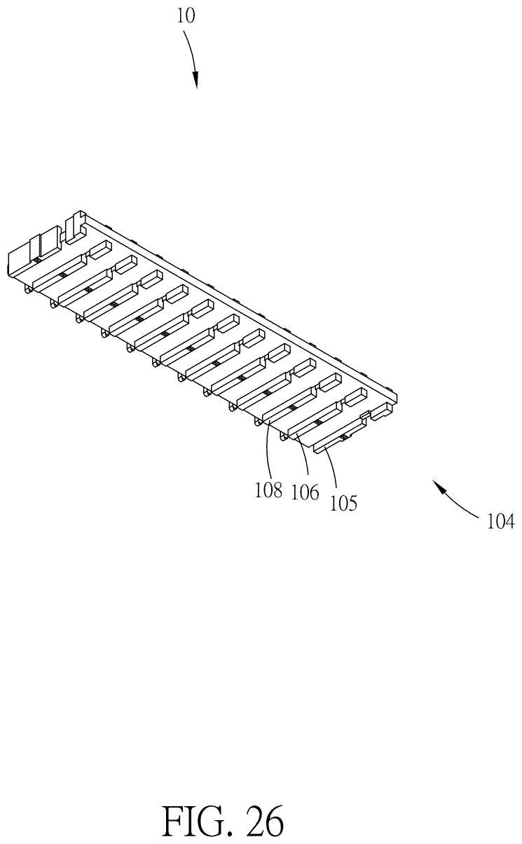

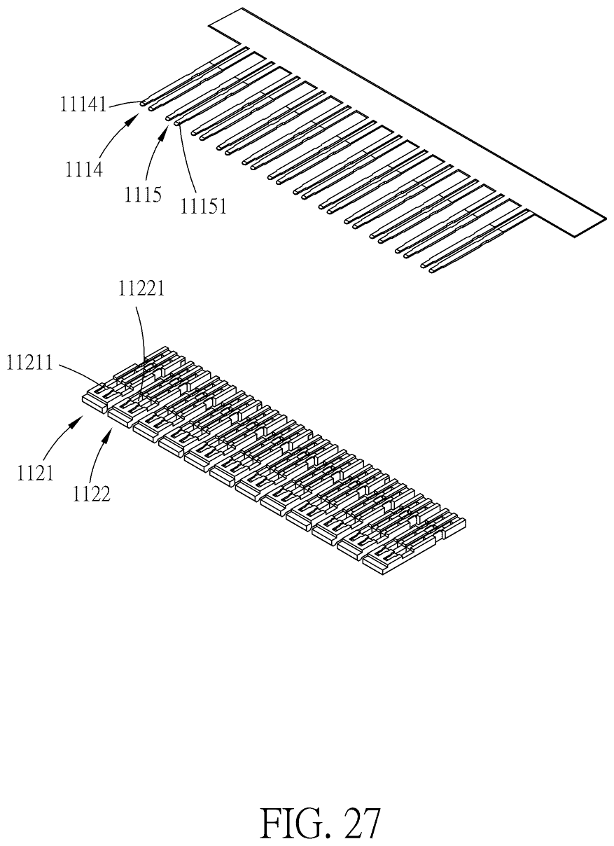

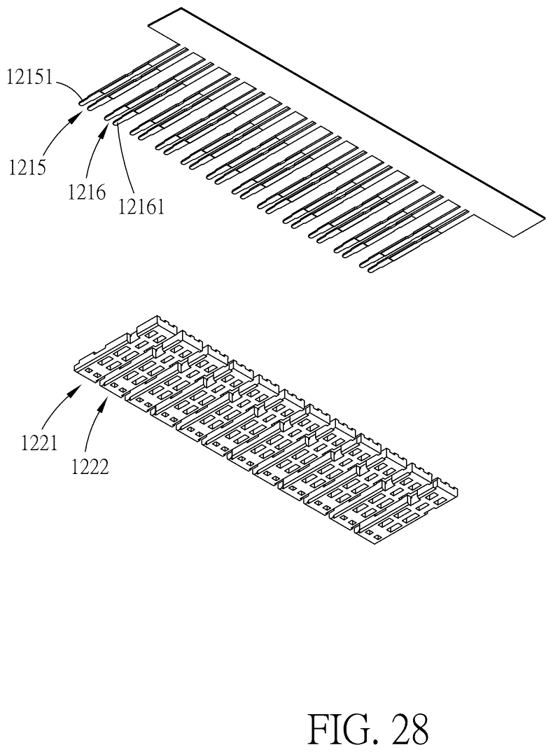

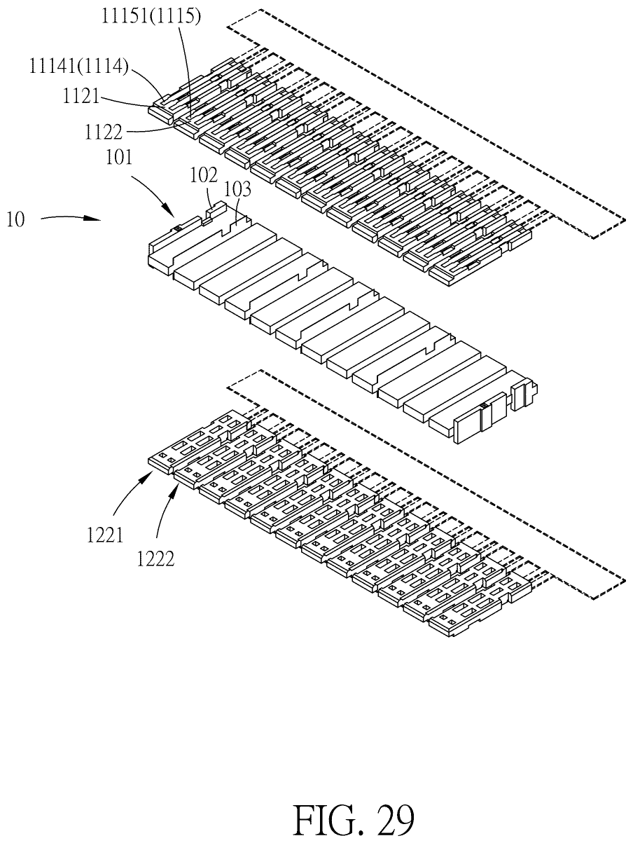

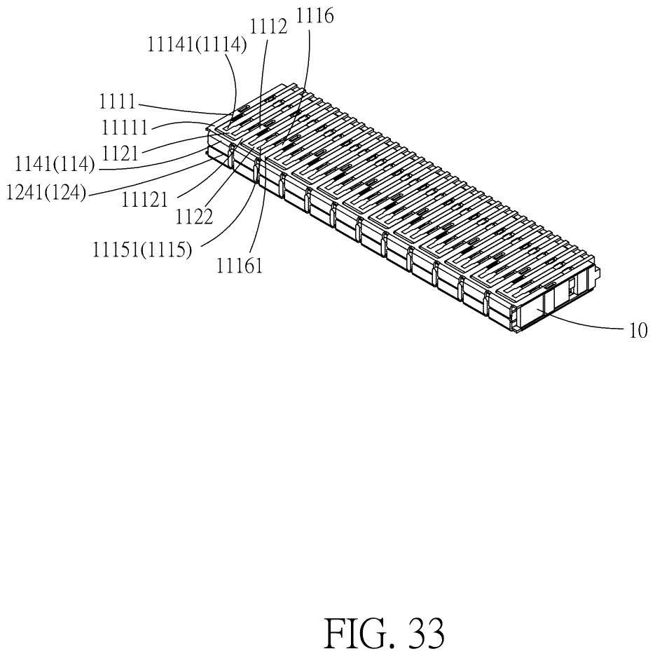

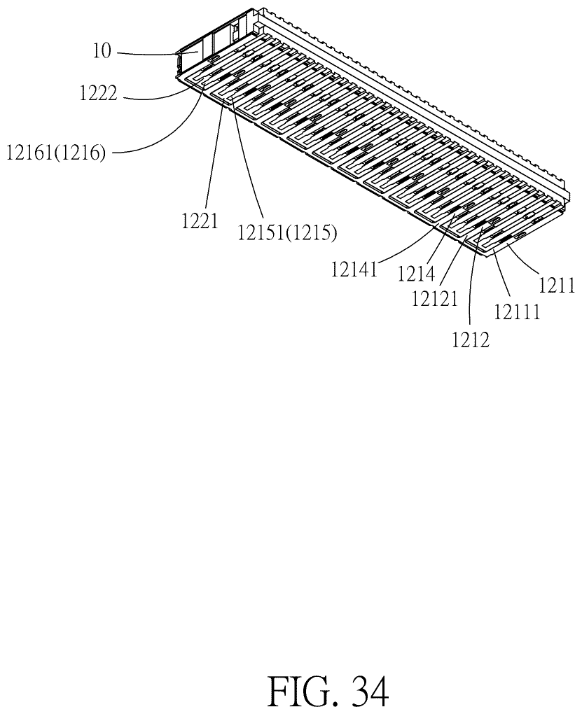

For a detailed description of the embodiments disclosed in the present application, please further refer to FIGS. 19 to 36.

In the above embodiment, provided is an electrical connector 1 that can be installed in electronic devices. In the electronic devices, the electrical connector 1 can be connected to a front-end conductive component to transmit signals. Additionally, the electrical connector 1 is respectively defined on both sides as an electrical connector major side S1 and an electrical connector minor side S2, and the front end of the electrical connector 1 is defined as an electrical connector front end E1.

It should be noted that in the above embodiment, the electrical connector 1 can join to the front-end conductive component on the electrical connector major side S1, the electrical connector minor side S2 and the electrical connector front end E1.

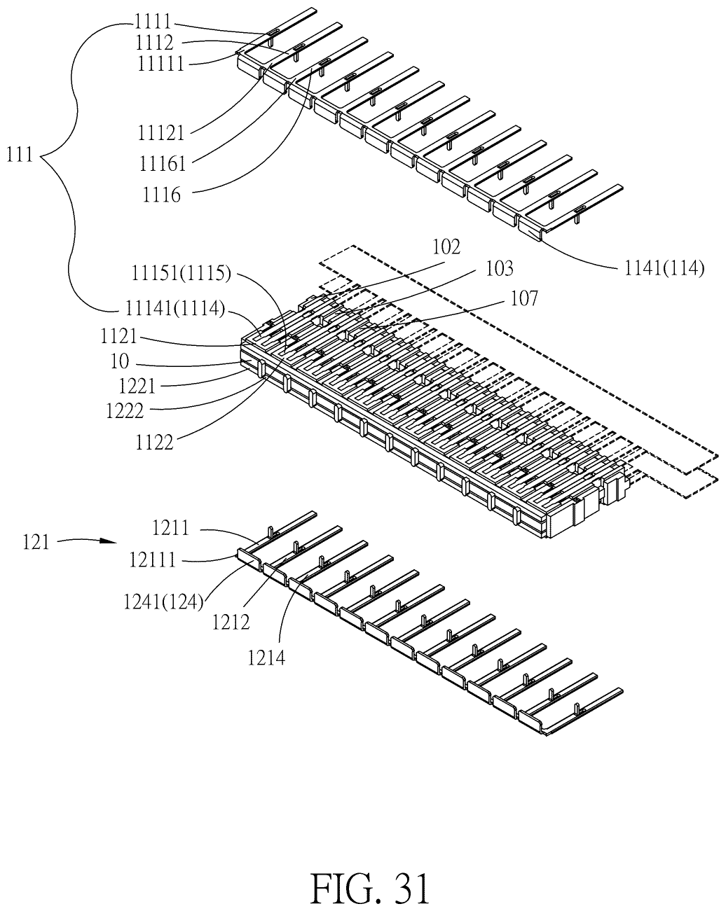

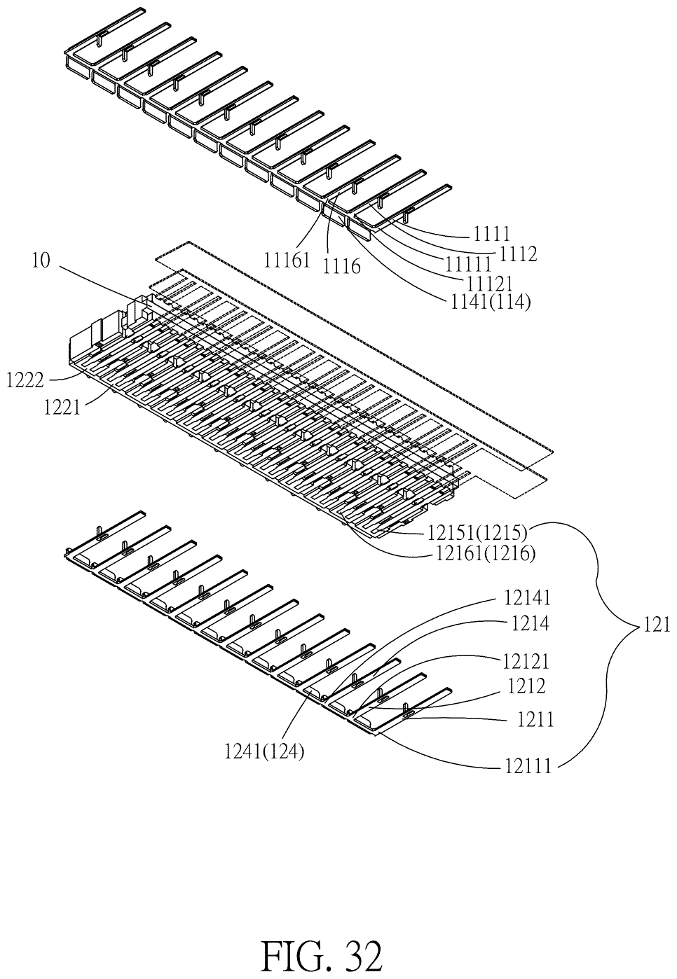

In the embodiments shown in FIGS. 31 to 32, the electrical connector 1 comprises: a conductive plastic base 10, a major conductive terminal assembly 111, a minor conductive terminal assembly 121, a major first insulation non-grounding terminal base 1121, a minor first insulation non-grounding terminal base 1221, a major second insulation non-grounding terminal base 1122, a minor second insulation non-grounding terminal base 1222, a major front conductive connecting body 114, and a minor front conductive connecting body 124.

It should be noted that the conductive plastic base 10 can be made of conductive plastic material, capable of providing to transmit shielded signals such as ground signals. The major first insulation non-grounding terminal base 1121, the minor first insulation non-grounding terminal base 1221, the major second insulation non-grounding terminal base 1122, and the minor second insulation non-grounding terminal base 1222 can be made of insulating material, providing positioning for the major conductive terminal assembly 111 and the minor conductive terminal assembly 121, respectively.

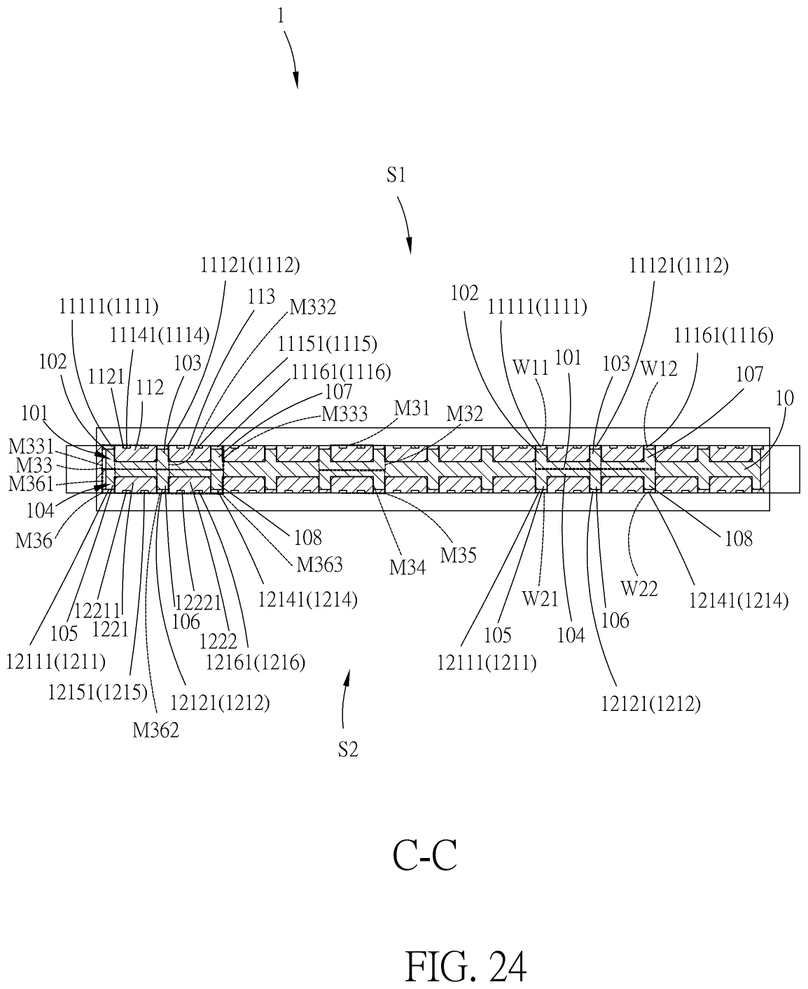

As shown in FIGS. 24 to 26, the conductive plastic base 10 comprises a major conductive plastic base body 101, a major first conductive plastic wall structure 102, a major second conductive plastic wall structure 103, a major third grounding terminal wall structure 107, a minor conductive plastic base body 104, a minor first conductive plastic wall structure 105, a minor second conductive plastic wall structure 106, and a minor third grounding terminal wall structure 108.

It should be noted that, the major conductive plastic base body 101 and the minor conductive plastic base body 104 can also be optionally formed separately or integrally.

As shown in FIGS. 19 to 21, the major conductive terminal assembly 111 is located on the electrical connector major side S1 and comprises a major first grounding conductive terminal 1111, a major second grounding conductive terminal 1112, a major third grounding conductive terminal 1116, a major first non-grounding conductive terminal 1114, and a major second non-grounding conductive terminal 1115. The minor conductive terminal assembly 121 is located on the electrical connector minor side S2 and comprises a minor first grounding conductive terminal 1211, a minor second grounding conductive terminal 1212, a minor third grounding conductive terminal 1214, a minor first non-grounding conductive terminal 1215, and a minor second non-grounding conductive terminal 1216.

It should be noted that the major first grounding conductive terminal 1111, the major second grounding conductive terminal 1112, the major third grounding conductive terminal 1116, the minor first grounding conductive terminal 1211, the minor second grounding conductive terminal 1212, and the minor third grounding conductive terminal 1214 can provide transmission of grounding signals, and the number of the major first grounding conductive terminal 1111, the major second grounding conductive terminal 1112, the major third grounding conductive terminal 1116, the minor first grounding conductive terminal 1211, the minor second grounding conductive terminal 1212, and the minor third grounding conductive terminal 1214 is not limited to one. The major first non-grounding conductive terminal 1114, the major second non-grounding conductive terminal 1115, the minor first non-grounding conductive terminal 1215, and the minor second non-grounding conductive terminal 1216 can provide transmission of non-grounding signals, such as differential signals, and the number of the major first non-grounding conductive terminal 1114, the major second non-grounding conductive terminal 1115, the minor first non-grounding conductive terminal 1215, and the minor second non-grounding conductive terminal 1216 is not limited to one.

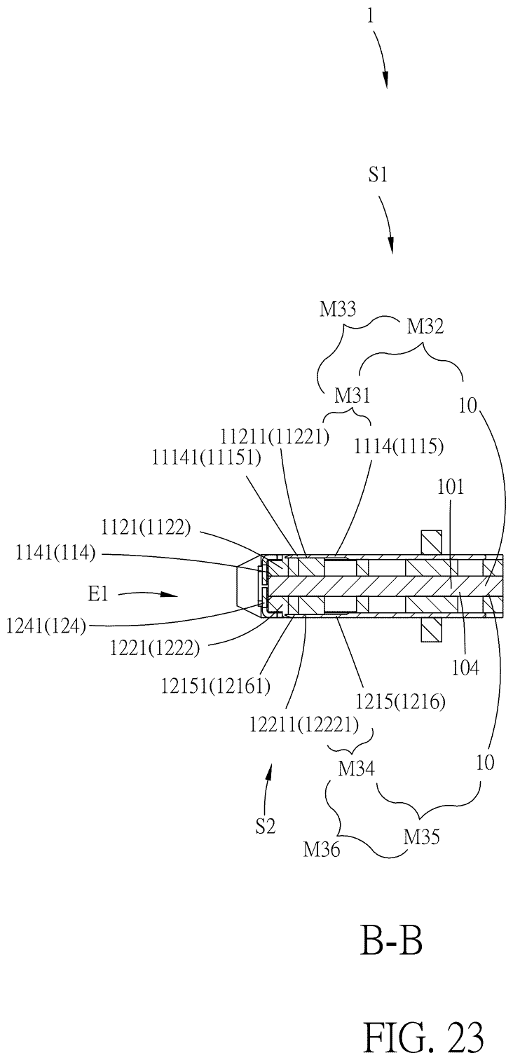

In the embodiments shown in FIGS. 23, the major first insulation non-grounding terminal base 1121 comprises a major first non-grounding terminal installation structure 11211, wherein the major first non-grounding terminal installation structure 11211 is provided to install the major first non-grounding conductive terminal 1114 to form a major first non-grounding conductive terminal installation module M31. Additionally, the major second insulation non-grounding terminal base 1122 comprises a major second non-grounding terminal installation structure 11221, wherein the major second non-grounding terminal installation structure 11221 is provided to install the major second non-grounding conductive terminal 1115 to form a major second non-grounding conductive terminal installation module M32.

It should be noted that the conductive plastic base 10 provides support for the major first non-grounding conductive terminal installation module M31 and the major second non-grounding conductive terminal installation module M32 to form a major grounding conductive terminal installation module M33. The major grounding conductive terminal installation module M33 comprises a major first grounding terminal installation structure M331, a major second grounding terminal installation structure M332, and a major third grounding terminal installation structure M333.

The major first grounding terminal installation structure M331 is provided to install the major first grounding conductive terminal 1111, the major second grounding terminal installation structure M332 is provided to install the major second grounding conductive terminal 1112, and the major third grounding terminal installation structure M333 is provided to install the major third grounding conductive terminal 1116, allowing the major first non-grounding conductive terminal 1114 to be positioned between the major first grounding conductive terminal 1111 and the major second grounding conductive terminal 1112, further allowing the major second non-grounding conductive terminal 1115 to be positioned between the major second grounding conductive terminal 1112 and the major third grounding conductive terminal 1116.

It should be noted that, in the major grounding conductive terminal installation module M33, the major first conductive plastic wall structure 102 is abutted against the major first grounding conductive terminal 1111, the major second conductive plastic wall structure 103 is abutted against the major second grounding conductive terminal 1112, and the major third grounding terminal wall structure 107 is abutted against the major third grounding conductive terminal 1116 to allow the conductive plastic base 10 to electrically connect to the major first grounding conductive terminal 1111, the major second grounding conductive terminal 1112, and the major third grounding conductive terminal 1116, enabling the major conductive plastic base body 101, the major first conductive plastic wall structure 102, the major second conductive plastic wall structure 103, the major first grounding conductive terminal 1111, and the major second grounding conductive terminal 1112 to form a major first non-grounding terminal shielding wall W11, and the major first non-grounding terminal shielding wall W11 can provide the transmission of a shielding signal, such as a grounding signal, and comprises a U-shaped cross-section, allowing the major first non-grounding terminal shielding wall W11 to provide a shielding wall on at least three sides of the major first non-grounding conductive terminal 1114, creating an electrically shielded environment for signal transmission of the major first non-grounding conductive terminal 1114, thereby reducing interference for the high-speed signal transmission of the electrical connector 1, optimizing the transmission quality of high-speed signals in the electrical connector 1, meeting the special requirements and development of electronic devices.

Additionally, the major conductive plastic base body 101, the major second conductive plastic wall structure 103, the major third grounding terminal wall structure 107, the major second grounding conductive terminal 1112, and the major third grounding conductive terminal 1116 to form a major second non-grounding terminal shielding wall W12, and the major second non-grounding terminal shielding wall W12 can provide the transmission of a shielding signal, such as a grounding signal, and comprises a U-shaped cross-section, allowing the major second non-grounding terminal shielding wall W12 to provide a shielding wall on at least three sides of the major second non-grounding conductive terminal 1115, creating an electrically shielded environment for signal transmission of the major second non-grounding conductive terminal 1115, thereby reducing interference for the high-speed signal transmission of the electrical connector 1, optimizing the transmission quality of high-speed signals in the electrical connector 1, meeting the special requirements and development of electronic devices.

Preferably, the major first conductive plastic wall structure 102 abut to the major first grounding conductive terminal 1111 in the way such as surface contact, providing structural support to the major first grounding conductive terminal 1111, the major second conductive plastic wall structure 103 abut to the major second grounding conductive terminal 1112 in the way such as surface contact, providing structural support to the major second grounding conductive terminal 1112, and the major third grounding terminal wall structure 103 abut to the major third grounding conductive terminal 1116 in the way such as surface contact, providing structural support to the major third grounding conductive terminal 1116 to reduce the degree of deformation experienced by the major first grounding conductive terminal 1111, the major second grounding conductive terminal 1112, and the major third grounding conductive terminal 1116.

As shown in FIGS. 24, 29, 31 and 35, the major conductive plastic base body 101 electrically connects to the major first conductive plastic wall structure 102, the major second conductive plastic wall structure 103 and the major third grounding terminal wall structure 107, enabling to provide transmission of shielding signals, such as grounding signals. Additionally, the major conductive plastic base body 101 extends around one side of the major first non-grounding conductive terminal 1114 and the major second non-grounding conductive terminal 1115, thereby providing an electrically shielded environment for signal transmission of the major first non-grounding conductive terminal 1114 and the major second non-grounding conductive terminal 1115.

Furthermore, as shown in FIGS. 24, 31, and 35, the major first grounding conductive terminal 1111 is inserted into the major first conductive plastic wall structure 102, the major second grounding conductive terminal 1112 is inserted into the major second conductive plastic wall structure 103, and the major third grounding conductive terminal 1116 is inserted into the major third grounding terminal wall structure 107, allowing the major first grounding conductive terminal 1111, the major second grounding conductive terminal 1112, and the major third grounding conductive terminal 1116 to electrically connect to the conductive plastic base 10.

The major first grounding conductive terminal 1111 comprises a major first grounding terminal front joining structure 11111, the major second grounding conductive terminal 1112 comprises a major second grounding terminal front joining structure 11121, the major third grounding conductive terminal 1116 comprises a major third grounding terminal front joining structure 11161, the major first non-grounding conductive terminal 1114 comprises a major first non-grounding terminal front joining structure 11141, and the major second non-grounding conductive terminal 1115 comprises a major second non-grounding terminal front joining structure 11151. The major first grounding terminal front joining structure 11111, the major second grounding terminal front joining structure 11121, the major third grounding terminal front joining structure 11161, the major first non-grounding terminal front joining structure 11141, and the major second non-grounding terminal front joining structure 11151 can be respectively joined to the front-end conductive component at the electrical connector front end E1 to provide transmission of electrical signals.

Additionally, as shown in FIGS. 23 and 24, the major front conductive connecting body 114 extends at the electrical connector front end E1 and spans over the major first non-grounding conductive terminal 1114 and the major second non-grounding conductive terminal 1115, and electrically connects to the major first grounding conductive terminal 1111, the major second grounding conductive terminal 1112, and the major third grounding conductive terminal 1116, allowing the major front conductive connecting body 114 to electrically connect to the major first non-grounding terminal shielding wall W11, providing shielding wall to the major first non-grounding conductive terminal 1114 at the electrical connector front end E1 to providing an electrical shielding environment for the signal transmission of the major first non-grounding conductive terminal 1114, thereby reducing interference when transmitting high-speed signals, optimizing the transmission quality of the electrical connector 1 to meet the specific requirements and development of electronic devices. Additionally, allowing the major front conductive connecting body 114 to electrically connect to the major second non-grounding terminal shielding wall W12, providing shielding wall to the major second non-grounding conductive terminal 1115 at the electrical connector front end E1 to providing an electrical shielding environment for the signal transmission of the major second non-grounding conductive terminal 1115, thereby reducing interference when transmitting high-speed signals, optimizing the transmission quality of the electrical connector 1 to meet the specific requirements and development of electronic devices.

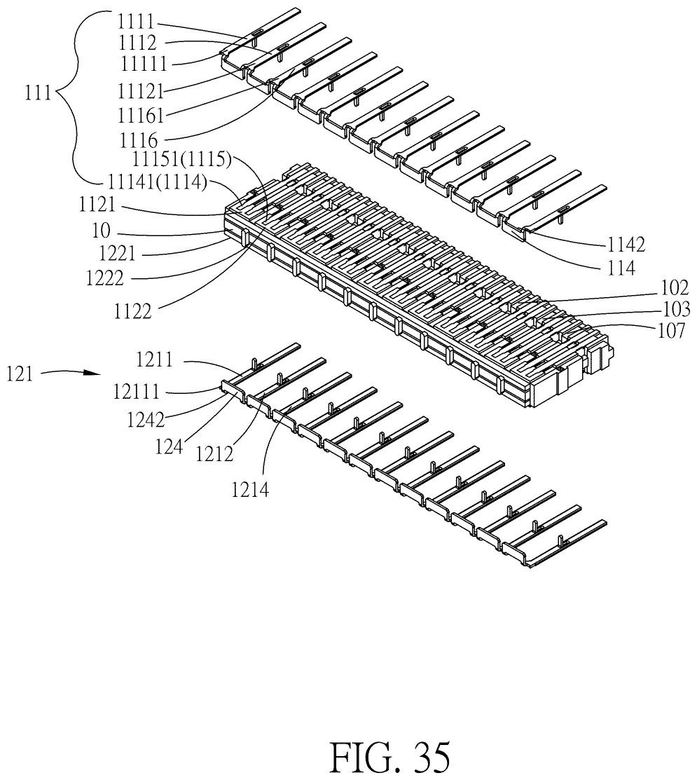

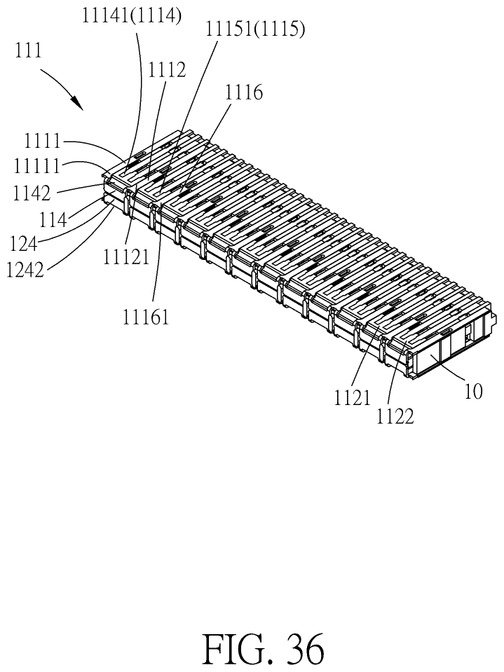

In the embodiments shown in FIGS. 23, 31, and 33, the major front conductive connecting body 114 comprises a major front wall shielding structure 1141, and the major front wall shielding structure 1141 provides a shielding wall for the major first non-grounding conductive terminal 1114 or the major second non-grounding conductive terminal 1115 at the electrical connector front end E1, providing an electrical shielding environment for signal transmission of the major first non-grounding conductive terminal 1114 or the major second non-grounding conductive terminal 1115. However, this is not limiting. In the embodiments illustrated in FIGS. 35 to 36, the major front conductive connecting body 114 comprises a major front connector hollow structure 1142, and the major front connector hollow structure 1142 is hollowed out at the electrical connector front end E1 to provide impedance matching for the major first non-grounding conductive terminal 1114 or the major second non-grounding conductive terminal 1115.

In the embodiments shown in FIGS. 23, the minor first insulation non-grounding terminal base 1221 comprises a minor first non-grounding terminal installation structure 12211, wherein the minor first non-grounding terminal installation structure 12211 is provided for installing the minor first non-grounding conductive terminal 1215, thereby forming a minor first non-grounding conductive terminal installation module M34. Additionally, the minor second insulation non-grounding terminal base 1222 comprises a minor second non-grounding terminal installation structure 12221, wherein the minor second non-grounding terminal installation structure 12221 is provided to install the minor second non-grounding conductive terminal 1216 to form a minor second non-grounding conductive terminal installation module M35.

It should be noted that the conductive plastic base 10 provides support for the minor first non-grounding conductive terminal installation module M34 and the minor second non-grounding conductive terminal installation module M35, forming a minor grounding conductive terminal installation module M36. The minor grounding conductive terminal installation module M36 comprises a minor first grounding terminal installation structure M361, a minor second grounding terminal installation structure M362, and a minor third grounding terminal installation structure M363.

The minor first grounding terminal installation structure M361 is provided for installing the minor first grounding conductive terminal 1211, the minor second grounding terminal installation structure M362 is provided for installing the minor second grounding conductive terminal 1212, and the minor third grounding terminal installation structure M363 is provided for installing the minor third grounding conductive terminal 1214, positioning the minor first non-grounding conductive terminal 1215 between the minor first grounding conductive terminal 1211 and the minor second grounding conductive terminal 1212, further positioning the minor second non-grounding conductive terminal 1216 between the minor second grounding conductive terminal 1212 and the minor third grounding conductive terminal 1214.

It should be noted that, in the minor grounding conductive terminal installation module M36, the minor first conductive plastic wall structure 105 is abutted against the minor first grounding conductive terminal 1211 to provide the structural support to the minor first grounding conductive terminal 1211, the minor second conductive plastic wall structure 106 is abutted against the minor second grounding conductive terminal 1212 to provide the structural support to the minor second grounding conductive terminal 1212, and the minor third grounding terminal wall structure 108 is abutted against the minor third grounding conductive terminal 1214 to provide the structural support to the minor third grounding conductive terminal 1214, enabling the conductive plastic base 10 to electrically connect the minor first grounding conductive terminal 1211, the minor second grounding conductive terminal 1212 and the minor third grounding conductive terminal 1214, allowing the conductive plastic base body 104, the minor first conductive plastic wall structure 105, the minor second conductive plastic wall structure 106, the minor first grounding conductive terminal 1211, and the minor second grounding conductive terminal 1212 to form a minor first non-grounding terminal shielding wall W21. The minor first non-grounding terminal shielding wall W21 can provide shielding signals such as ground signals and comprises a U-shaped cross-section, allowing the minor first non-grounding terminal shielding wall W21 to provide a shielding wall on at least three sides of the minor first non-grounding conductive terminal 1215 to create an electrically shielded environment for signal transmission of the minor first non-grounding conductive terminal 1215, reducing interference during transmission of high-speed signals by the electrical connector 1, thereby enhancing the transmission quality of high-speed signals by the electrical connector 1, meeting the special requirements and development needs of electronic devices.

Additionally, the minor conductive plastic base body 104, the minor second conductive plastic wall structure 106, the minor third grounding terminal wall structure 108, the minor second grounding conductive terminal 1212, and the minor third grounding conductive terminal 1214 to form a minor second non-grounding terminal shielding wall W22, and the minor second non-grounding terminal shielding wall W22 can provide the transmission of a shielding signal, such as a grounding signal, and comprises a U-shaped cross-section, allowing the minor second non-grounding terminal shielding wall W22 to provide a shielding wall on at least three sides of the minor second non-grounding conductive terminal 1216, creating an electrically shielded environment for signal transmission of the minor second non-grounding conductive terminal 1216, thereby reducing interference for the high-speed signal transmission of the electrical connector 1, optimizing the transmission quality of high-speed signals in the electrical connector 1, meeting the special requirements and development of electronic devices.

Preferably, the minor first conductive plastic wall structure 105 abut to the minor first grounding conductive terminal 1211 in the way such as surface contact, providing structural support to the minor first grounding conductive terminal 1211, the minor second conductive plastic wall structure 106 abut to the minor second grounding conductive terminal 1212 in the way such as surface contact, providing structural support to the minor second grounding conductive terminal 1212, and the minor third grounding terminal wall structure 108 abut to the minor third grounding conductive terminal 1214 in the way such as surface contact, providing structural support to the minor third grounding conductive terminal 1214 to reduce the degree of deformation experienced by the minor first grounding conductive terminal 1211, the minor second grounding conductive terminal 1212, and the minor third grounding conductive terminal 1214.

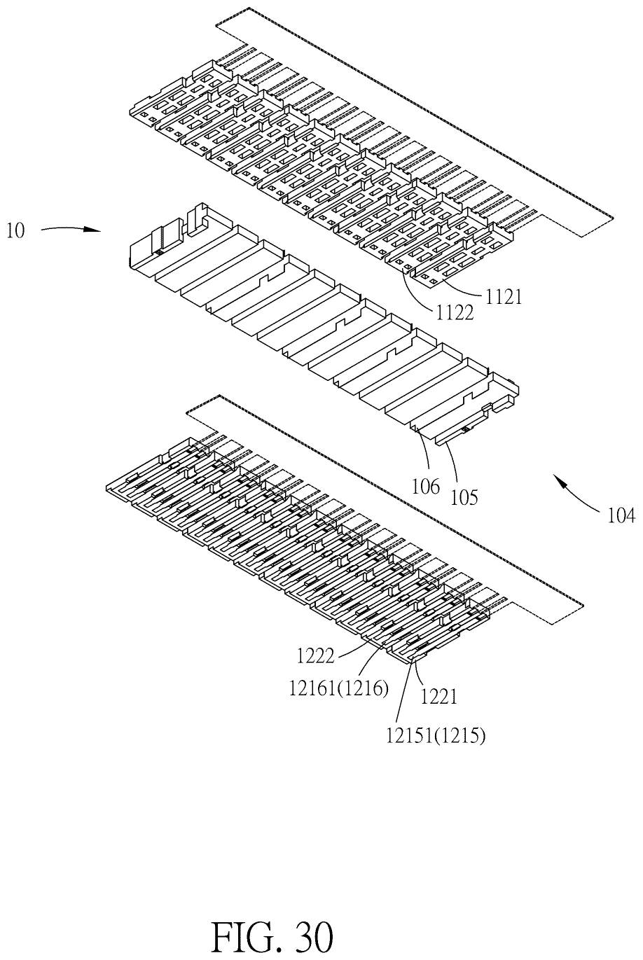

As shown in FIGS. 23 and 30, the minor conductive plastic base body 104 electrically connects to the minor first conductive plastic wall structure 105, the minor second conductive plastic wall structure 106 and the minor third grounding terminal wall structure 108, enabling to provide transmission of shielding signals, such as grounding signals. Additionally, the minor conductive plastic base body 104 extends around one side of the minor first non-grounding conductive terminal 1215 and the minor second non-grounding conductive terminal 1216, thereby providing an electrically shielded environment for signal transmission of the minor first non-grounding conductive terminal 1215 and the minor second non-grounding conductive terminal 1216.

Furthermore, as shown in FIG. 24, the minor first grounding conductive terminal 1211 is inserted into the minor first conductive plastic wall structure 105, the minor second grounding conductive terminal 1212 is inserted into the minor second conductive plastic wall structure 106, and the minor third grounding conductive terminal 1214 is inserted into the minor third grounding terminal wall structure 108, allowing the minor first grounding conductive terminal 1211, the minor second grounding conductive terminal 1212, and the minor third grounding conductive terminal 1214 to electrically connect to the conductive plastic base 10.

The minor first grounding conductive terminal 1211 comprises a minor first grounding terminal front joining structure 12111, the minor second grounding conductive terminal 1212 comprises a minor second grounding terminal front joining structure 12121, the minor third grounding conductive terminal 1214 comprises a minor third grounding terminal front joining structure 12141, the minor first non-grounding conductive terminal 1215 comprises a minor first non-grounding terminal front joining structure 12151, and the minor second non-grounding conductive terminal 1216 comprises a minor second non-grounding terminal front joining structure 12161. The minor first grounding terminal front joining structure 12111, the minor second grounding terminal front joining structure 12121, the minor third grounding terminal front joining structure 12141, the minor first non-grounding terminal front joining structure 12151, and the minor second non-grounding terminal front joining structure 12161 can be respectively joined to the front-end conductive component at the electrical connector front end E1 to provide transmission of electrical signals.

Additionally, as shown in FIG. 24, the minor front conductive connecting body 124 extends at the electrical connector front end E1 and spans over the minor first non-grounding conductive terminal 1215 and the minor second non-grounding conductive terminal 1216, and electrically connects to the minor first grounding conductive terminal 1211, the minor second grounding conductive terminal 1212, and the minor third grounding conductive terminal 1214, allowing the minor front conductive connecting body 124 to electrically connect to the minor first non-grounding terminal shielding wall W21, providing shielding wall to the minor first non-grounding conductive terminal 1215 at the electrical connector front end E1 to providing an electrical shielding environment for the signal transmission of the minor first non-grounding conductive terminal 1215, thereby reducing interference when transmitting high-speed signals, optimizing the transmission quality of the electrical connector 1 to meet the specific requirements and development of electronic devices. Additionally, allowing the minor front conductive connecting body 124 to electrically connect to the minor second non-grounding terminal shielding wall W22, providing shielding wall to the minor second non-grounding conductive terminal 1216 at the electrical connector front end E1 to providing an electrical shielding environment for the signal transmission of the minor second non-grounding conductive terminal 1216, thereby reducing interference when transmitting high-speed signals, optimizing the transmission quality of the electrical connector 1 to meet the specific requirements and development of electronic devices.

In the embodiments shown in FIGS. 23 and 32, the minor front conductive connecting body 124 comprises a minor front wall shielding structure 1241, and the minor front wall shielding structure 1241 provides a shielding wall for the minor first non-grounding conductive terminal 1215 or the minor second non-grounding conductive terminal 1216 at the electrical connector front end E1, providing an electrical shielding environment for signal transmission of the minor first non-grounding conductive terminal 1215 or the minor second non-grounding conductive terminal 1216. However, this is not limiting. In the embodiments illustrated in FIGS. 35 to 36, the minor front conductive connecting body 124 comprises a minor front connector hollow structure 1242, and the minor front connector hollow structure 1242 is hollowed out at the electrical connector front end E1 to provide impedance matching for the minor first non-grounding conductive terminal 1215 or the minor second non-grounding conductive terminal 1216.

It should be noted that, in the embodiments described in the present application, certain components may be optionally omitted. For example, the electrical connector may selectively include: a major conductive terminal assembly, a major first insulation non-grounding terminal base, a major second insulation non-grounding terminal base, and a conductive plastic base. The major conductive terminal assembly is located on the electrical connector major side and comprises a major first grounding conductive terminal, a major second grounding conductive terminal, a major third grounding conductive terminal, a major first non-grounding conductive terminal, and a major second non-grounding conductive terminal. The major first insulation non-grounding terminal base comprises a major first non-grounding terminal installation structure, wherein the major first non-grounding terminal installation structure provides for the installation of the major first non-grounding conductive terminal to form a major first non-grounding conductive terminal installation module. The major second insulation non-grounding terminal base comprises a major second non-grounding terminal installation structure, wherein the major second non-grounding terminal installation structure provides for the installation of the major second non-grounding conductive terminal to form a major second non-grounding conductive terminal installation module. The conductive plastic base provides support for supporting the major first non-grounding conductive terminal installation module and the major second non-grounding conductive terminal installation module to form a major grounding conductive terminal installation module. The conductive plastic base comprises a major conductive plastic base body, a major first conductive plastic wall structure, a major second conductive plastic wall structure, and major third grounding terminal wall structure. The major conductive plastic base body electrically connects to the major first conductive plastic wall structure, the major second conductive plastic wall structure, and the major third grounding terminal wall structure. The major grounding conductive terminal installation module comprises a major first grounding terminal installation structure, a major second grounding terminal installation structure, and a major third grounding terminal installation structure, wherein the major first grounding terminal installation structure is provided for the installation of the major first grounding conductive terminal, the major second grounding terminal installation structure is provided for the installation of the major second grounding conductive terminal, and the major third grounding terminal installation structure is provided for the installation of the major third grounding conductive terminal, allowing the major first non-grounding conductive terminal is located between the major first grounding conductive terminal and the major second grounding conductive terminal, further allowing the major second non-grounding conductive terminal is located between the major second grounding conductive terminal and the major third grounding conductive terminal. In the major grounding conductive terminal installation module, the major first conductive plastic wall structure is abutted against the major first grounding conductive terminal to provide structural support for the major first grounding conductive terminal, the major second conductive plastic wall structure is abutted against the major second grounding conductive terminal to provide structural support for the major second grounding conductive terminal, and the major third grounding terminal wall structure is abutted against the major third grounding conductive terminal to provide structural support for the major third grounding conductive terminal, allowing the conductive plastic base electrically connects to the major first grounding conductive terminal, the major second grounding conductive terminal, and the major third grounding conductive terminal, thereby enabling the major conductive plastic base body, the major first conductive plastic wall structure, the major second conductive plastic wall structure, the major first grounding conductive terminal, and the major second grounding conductive terminal to form a major first non-grounding terminal shielding wall. The major first non-grounding terminal shielding wall comprises a U-shaped cross-section and provides shielding walls on at least three sides of the major first non-grounding conductive terminal, further enabling the major conductive plastic base body, the major second conductive plastic wall structure, the major third grounding terminal wall structure, the major second grounding conductive terminal, and the major third grounding conductive terminal to form a major second non-grounding terminal shielding wall. The major second non-grounding terminal shielding wall comprises a U-shaped cross-section and provides shielding walls on at least three sides of the major second non-grounding conductive terminal.

In summary, the electrical connector provided in this application can provide shielding walls to transmit shielded signals for at least three sides of the non-grounding conductive terminal, thereby effectively reducing interference when transmitting high-speed signals, and optimizing the transmission quality of the electrical connector for high-speed signals to meet the specific requirements and advancements of electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, wherein one side of the electrical connector is an electrical connector major side, comprising:
a major conductive terminal assembly, located on the electrical connector major side, comprising a major first grounding conductive terminal, a major second grounding conductive terminal, and a major non-grounding conductive terminal;
a major insulation terminal base, comprising a major non-grounding terminal installation structure, wherein the major non-grounding terminal installation structure provides for the installation of the major non-grounding conductive terminal to form a major non-grounding conductive terminal installation module;
a conductive plastic base for supporting the major non-grounding conductive terminal installation module to form a major grounding conductive terminal installation module, and the conductive plastic base comprises a major conductive plastic base body, a major first conductive plastic wall structure, and a major second conductive plastic wall structure, and the major conductive plastic base body electrically connects to the major first conductive plastic wall structure and the major second conductive plastic wall structure, and the major grounding conductive terminal installation module comprises a major first grounding terminal installation structure and a major second grounding terminal installation structure, wherein the major first grounding terminal installation structure is provided for installing the major first grounding conductive terminal and the major second grounding terminal installation structure is provided for installing the major second grounding conductive terminal, allowing the major non-grounding conductive terminal to be positioned between the major first grounding conductive terminal and the major second grounding conductive terminal, in the major grounding conductive terminal installation module, the major first conductive plastic wall structure is abutted against the major first grounding conductive terminal, and the major second conductive plastic wall structure is abutted against the major second grounding conductive terminal to allow the conductive plastic base to electrically connect to the major first grounding conductive terminal and the major second grounding conductive terminal, enabling the major conductive plastic base body, the major first conductive plastic wall structure, the major second conductive plastic wall structure, the major first grounding conductive terminal, and the major second grounding conductive terminal to form a major non-grounding terminal shielding wall, and the major non-grounding terminal shielding wall comprises a U-shaped cross-section, allowing the major non-grounding terminal shielding wall to provide a shielding wall on at least three sides of the major non-grounding conductive terminal.

2. The electrical connector of claim 1, wherein the front end of the electrical connector is an electrical connector front end, and the electrical connector further comprises a major front conductive connecting body, wherein the major front conductive connecting body extends at the electrical connector front end and spans over the major non-grounding conductive terminal, electrically connecting to the major first grounding conductive terminal and the major second grounding conductive terminal, enabling the major front conductive connecting body to electrically connect to the major non-grounding terminal shielding wall, thereby providing electrical shielding to the major non-grounding conductive terminal at the electrical connector front end, wherein the major first grounding conductive terminal comprises a major first grounding terminal front joining structure, the major second grounding conductive terminal comprises a major second grounding terminal front joining structure, and the major non-grounding conductive terminal comprises a major non-grounding terminal front joining structure, additionally, the major first grounding terminal front joining structure, the major second grounding terminal front joining structure, and the major non-grounding terminal front joining structure are respectively located at the electrical connector front end.

3. The electrical connector of claim 2, wherein the major front conductive connector comprises a major front wall shielding structure, and the major front wall shielding structure provides a shielding wall for the major non-grounding conductive terminal at the electrical connector front end.

4. The electrical connector of claim 2, wherein the major front conductive connector comprises a major front connector hollow structure, and the major front connector hollow structure is hollowed out at the electrical connector front end to provide impedance matching for the major non-grounding conductive terminal.

5. The electrical connector of claim 1, wherein the major conductive plastic base body extends around one side of the major non-grounding conductive terminal.

6. The electrical connector of claim 1, wherein the major first grounding conductive terminal is inserted into the major first conductive plastic wall structure, and the major second grounding conductive terminal is inserted into the major second conductive plastic wall structure, allowing the major first grounding conductive terminal and the major second grounding conductive terminal to electrically connect to the conductive plastic base.

7. The electrical connector of claim 1, wherein the major first conductive plastic wall structure and the major second conductive plastic wall structure respectively enter the major insulation terminal base, allowing the major first conductive plastic wall structure to abut against the major first grounding conductive terminal and allowing the major second conductive plastic wall structure to abut against the major second grounding conductive terminal.

8. The electrical connector of claim 1, wherein the major first conductive plastic wall structure abuts against the major first grounding conductive terminal in surface contact and the major second conductive plastic wall structure abuts against the major second grounding conductive terminal in surface contact, providing structural support for the major first grounding conductive terminal and the major second grounding conductive terminal respectively.

9. The electrical connector of claim 1, wherein the other side of the electrical connector is an electrical connector minor side, wherein the conductive plastic base also comprises a minor conductive plastic base body, a minor first conductive plastic wall structure, and a minor second conductive plastic wall structure, and the minor conductive plastic base body electrically connects to the minor first conductive plastic wall structure and the minor second conductive plastic wall structure, and the electrical connector further comprises:
a minor conductive terminal assembly, located on the electrical connector minor side, comprising a minor first grounding conductive terminal, a minor second grounding conductive terminal, and a minor non-grounding conductive terminal;
a minor insulation terminal base, comprising a minor non-grounding terminal installation structure, wherein the minor non-grounding terminal installation structure provides the installation for the minor non-grounding conductive terminal, forming a minor non-grounding conductive terminal installation module; the conductive plastic base provides support for minor non-grounding conductive terminal installation module, forming a minor grounding conductive terminal installation module, and the minor grounding conductive terminal installation module comprises a minor first grounding terminal installation structure and a minor second grounding terminal installation structure, wherein the minor first grounding terminal installation structure provides the installation for the minor first grounding conductive terminal, and the minor second grounding terminal installation structure provides the installation for the minor second grounding conductive terminal, positioning the minor non-grounding conductive terminal between the minor first grounding conductive terminal and the minor second grounding conductive terminal, within the minor grounding conductive terminal installation module, the minor first conductive plastic wall structure abuts against the minor first grounding conductive terminal, and the minor second conductive plastic wall structure abuts against the minor second grounding conductive terminal, enabling the conductive plastic base to electrically connect the minor first grounding conductive terminal and the minor second grounding conductive terminal, allowing the minor conductive plastic base body, the minor first conductive plastic wall structure, the minor second conductive plastic wall structure, the minor first grounding conductive terminal, and the minor second grounding conductive terminal together form a minor non-grounding terminal shielding wall, and the minor non-grounding terminal shielding wall comprises a U-shaped cross-section, allowing the minor non-grounding terminal shielding wall to provide a shielding wall on at least three sides of the minor non-grounding conductive terminal.

10. The electrical connector of claim 9, wherein the front end of the electrical connector is an electrical connector front end, and the electrical connector comprises a minor front conductive connecting body, and the minor front conductive connecting body extends at the electrical connector front end and spans over the minor non-grounding conductive terminal, electrically connecting to the minor first grounding conductive terminal and the minor second grounding conductive terminal, enabling the minor front conductive connecting body to electrically connect to the minor non-grounding terminal shielding wall and to provide the electrical shielding to the minor non-grounding conductive terminal at the electrical connector front end, wherein the minor first grounding conductive terminal comprises a minor first grounding terminal front joining structure, the minor second grounding conductive terminal comprises a minor second grounding terminal front joining structure, and the minor non-grounding conductive terminal comprises a minor non-grounding terminal front joining structure, additionally, the minor first grounding terminal front joining structure, the minor second grounding terminal front joining structure, and the minor non-grounding terminal front joining structure are located at the electrical connector front end.

11. The electrical connector of claim 10, wherein the minor front conductive connecting body comprises a minor front wall shielding structure, and the minor front wall shielding structure is provided at the electrical connector front end to serve as a shielding wall for the minor non-grounding conductive terminal.

12. The electrical connector of claim 10, wherein the minor front conductive connecting body comprises a minor front connector hollow structure, and the minor front connector hollow structure is hollowed out at the electrical connector front end to provide impedance matching for the minor non-grounding conductive terminal.

13. The electrical connector of claim 9, wherein the minor conductive plastic base body extends around one side of the minor non-grounding conductive terminal.

14. The electrical connector of claim 9, wherein the minor first grounding conductive terminal and the minor second grounding conductive terminal are respectively inserted into the minor first conductive plastic wall structure and the minor second conductive plastic wall structure, allowing the minor first grounding conductive terminal and the minor second grounding conductive terminal to electrically connect to the conductive plastic base.

15. The electrical connector of claim 9, wherein the minor first conductive plastic wall structure and the minor second conductive plastic wall structure respectively enter the minor insulation terminal base, enabling to individually abut against the minor first grounding conductive terminal and the minor second grounding conductive terminal.

16. The electrical connector of claim 9, wherein the minor first conductive plastic wall structure and the minor second conductive plastic wall structure individually abut against the minor first grounding conductive terminal and the minor second grounding conductive terminal in surface contact, providing structural support for the minor first grounding conductive terminal and the minor second grounding conductive terminal respectively.

17. The electrical connector of claim 9, wherein the major insulation terminal base and the minor insulation terminal base can be formed separately or integrally.

18. The electrical connector of claim 9, wherein the major conductive plastic base body and the minor conductive plastic base body can be formed separately or integrally.

19. An electrical connector, wherein one side of the electrical connector is an electrical connector major side, comprising:
a major conductive terminal assembly, located on the electrical connector major side, comprising a major first grounding conductive terminal, a major second grounding conductive terminal, a major third grounding conductive terminal, a major first non-grounding conductive terminal and a major second non-grounding conductive terminal;
a major first insulation non-grounding terminal base, comprising a major first non-grounding terminal installation structure, wherein the major first non-grounding terminal installation structure provides for the installation of the major first non-grounding conductive terminal to form a major first non-grounding conductive terminal installation module;
a major second insulation non-grounding terminal base, comprising a major second non-grounding terminal installation structure, wherein the major second non-grounding terminal installation structure provides for the installation of the major second non-grounding conductive terminal to form a major second non-grounding conductive terminal installation module; and
a conductive plastic base for supporting the major first non-grounding conductive terminal installation module and the major second non-grounding conductive terminal installation module to form a major grounding conductive terminal installation module, and the conductive plastic base comprises a major conductive plastic base body, a major first conductive plastic wall structure, a major second conductive plastic wall structure, and a major third grounding terminal wall structure, and the major conductive plastic base body electrically connects to the major first conductive plastic wall structure, the major second conductive plastic wall structure, and the major third grounding terminal wall structure, and the major grounding conductive terminal installation module comprises a major first grounding terminal installation structure, a major second grounding terminal installation structure, and a major third grounding terminal installation structure, wherein the major first grounding terminal installation structure is provided for installing the major first grounding conductive terminal, the major second grounding terminal installation structure is provided for installing the major second grounding conductive terminal, and the major third grounding terminal installation structure is provided for installing the major third grounding conductive terminal, allowing the major first non-grounding conductive terminal to be positioned between the major first grounding conductive terminal and the major second grounding conductive terminal and allowing the major second non-grounding conductive terminal to be positioned between the major second grounding conductive terminal and the major third grounding conductive terminal, in the major grounding conductive terminal installation module, the major first conductive plastic wall structure is abutted against the major first grounding conductive terminal, the major second conductive plastic wall structure is abutted against the major second grounding conductive terminal, and the major third grounding terminal wall structure is abutted against the major third grounding conductive terminal to allow the conductive plastic base to electrically connect to the major first grounding conductive terminal, the major second grounding conductive terminal, and the major third grounding conductive terminal, enabling the major conductive plastic base body, the major first conductive plastic wall structure, the major second conductive plastic wall structure, the major first grounding conductive terminal, and the major second grounding conductive terminal to form a major first non-grounding terminal shielding wall, and the major first non-grounding terminal shielding wall comprises a U-shaped cross-section, allowing the major first non-grounding terminal shielding wall to provide a shielding wall on at least three sides of the major first non-grounding conductive terminal, further enabling the major conductive plastic base body, the major second conductive plastic wall structure, the major third grounding terminal wall structure, the major second grounding conductive terminal, and the major third grounding conductive terminal to form a major second non-grounding terminal shielding wall, and the major second non-grounding terminal shielding wall comprises a U-shaped cross-section, allowing the major second non-grounding terminal shielding wall to provide a shielding wall on at least three sides of the major second non-grounding conductive terminal.

20. The electrical connector of claim 19, wherein the front end of the electrical connector is an electrical connector front end, and the electrical connector further comprises a major front conductive connecting body, wherein the major front conductive connecting body extends at the electrical connector front end and spans over the major first non-grounding conductive terminal and the major second non-grounding conductive terminal, electrically connecting to the major first grounding conductive terminal, the major second grounding conductive terminal, and the major third grounding conductive terminal, enabling the major front conductive connecting body to electrically connect to the major first non-grounding terminal shielding wall, thereby providing electrical shielding to the major first non-grounding conductive terminal at the electrical connector front end, further enabling the major front conductive connecting body to electrically connect to the major second non-grounding terminal shielding wall, thereby providing electrical shielding to the major second non-grounding conductive terminal at the electrical connector front end, wherein the major first grounding conductive terminal comprises a major first grounding terminal front joining structure, the major second grounding conductive terminal comprises a major second grounding terminal front joining structure, the major third grounding conductive terminal comprises a major third grounding terminal front joining structure, the major third grounding conductive terminal comprises a major third grounding terminal front joining structure, the major first non-grounding conductive terminal comprises a major first non-grounding terminal front joining structure, and the major second non-grounding conductive terminal comprises a major second non-grounding terminal front joining structure, additionally, the major first grounding terminal front joining structure, the major second grounding terminal front joining structure, the major third grounding terminal front joining structure, the major first non-grounding terminal front joining structure, and the major second non-grounding terminal front joining structure are respectively located at the electrical connector front end.

21. The electrical connector of claim 20, wherein the major front conductive connector comprises a major front wall shielding structure, and the major front wall shielding structure provides a shielding wall for the major first non-grounding conductive terminal or the major second non-grounding conductive terminal at the electrical connector front end.

22. The electrical connector of claim 20, wherein the major front conductive connector comprises a major front connector hollow structure, and the major front connector hollow structure is hollowed out at the electrical connector front end to provide impedance matching for the major first non-grounding conductive terminal and the major second non-grounding conductive terminal.

23. The electrical connector of claim 19, wherein the major conductive plastic base body extends around one side of the major first non-grounding conductive terminal and the major second non-grounding conductive terminal.

24. The electrical connector of claim 19, wherein the major first grounding conductive terminal is inserted into the major first conductive plastic wall structure, the major second grounding conductive terminal is inserted into the major second conductive plastic wall structure, and the major third grounding conductive terminal is inserted into the major third grounding terminal wall structure, allowing the major first grounding conductive terminal, the major second grounding conductive terminal, and the major third grounding conductive terminal to electrically connect to the conductive plastic base.

25. The electrical connector of claim 19, wherein the major first conductive plastic wall structure abuts against the major first grounding conductive terminal in surface contact, the major second conductive plastic wall structure abuts against the major second grounding conductive terminal in surface contact, and the major third grounding terminal wall structure abuts against the major third grounding conductive terminal in surface contact, providing structural support for the major first grounding conductive terminal, the major second grounding conductive terminal, and the major third grounding conductive terminal respectively.

26. The electrical connector of claim 19, wherein the other side of the electrical connector is an electrical connector minor side, wherein the conductive plastic base also comprises a minor conductive plastic base body, a minor first conductive plastic wall structure, and a minor second conductive plastic wall structure, and a minor third grounding terminal wall structure, and the minor conductive plastic base body electrically connects to the minor first conductive plastic wall structure and the minor second conductive plastic wall structure, and the minor third grounding terminal wall structure, and the electrical connector further comprises:
a minor conductive terminal assembly, located on the electrical connector minor side, comprising a minor first grounding conductive terminal, a minor second grounding conductive terminal, a minor third grounding conductive terminal, a minor first non-grounding conductive terminal, and a minor second non-grounding conductive terminal;
a minor first insulation non-grounding terminal base, comprising a minor first non-grounding terminal installation structure, wherein the minor first non-grounding terminal installation structure provides the installation for the minor first non-grounding conductive terminal, forming a minor first non-grounding conductive terminal installation module;
a minor second insulation non-grounding terminal base, comprising a minor second non-grounding terminal installation structure, wherein the minor second non-grounding terminal installation structure provides the installation for the minor second non-grounding conductive terminal, forming a minor second non-grounding conductive terminal installation module; wherein
the conductive plastic base provides support for the minor first non-grounding conductive terminal installation module and the minor second non-grounding conductive terminal installation module, forming a minor grounding conductive terminal installation module, and the minor grounding conductive terminal installation module comprises a minor first grounding terminal installation structure, a minor second grounding terminal installation structure, and a minor third grounding terminal installation structure, wherein the minor first grounding terminal installation structure provides the installation for the minor first grounding conductive terminal, the minor second grounding terminal installation structure provides the installation for the minor second grounding conductive terminal, and the minor third grounding terminal installation structure provides the installation for the minor third grounding conductive terminal, positioning the minor first non-grounding conductive terminal between the minor first grounding conductive terminal and the minor second grounding conductive terminal, further positioning the minor second non-grounding conductive terminal between the minor second grounding conductive terminal and the minor third grounding conductive terminal, within the minor grounding conductive terminal installation module, the minor first conductive plastic wall structure abuts against the minor first grounding conductive terminal, the minor second conductive plastic wall structure abuts against the minor second grounding conductive terminal, and the minor third grounding terminal wall structure abuts against the minor third grounding conductive terminal, enabling the conductive plastic base to electrically connect to the minor first grounding conductive terminal, the minor second grounding conductive terminal, and the minor third grounding conductive terminal, allowing the minor conductive plastic base body, the minor first conductive plastic wall structure, the minor second conductive plastic wall structure, the minor first grounding conductive terminal, and the minor second grounding conductive terminal together form a minor first non-grounding terminal shielding wall, and the minor first non-grounding terminal shielding wall comprises a U-shaped cross-section, allowing the minor first non-grounding terminal shielding wall to provide a shielding wall on at least three sides of the minor first non-grounding conductive terminal, further allowing the minor conductive plastic base body, the minor second conductive plastic wall structure, the minor third grounding terminal wall structure, the minor second grounding conductive terminal, and the minor third grounding conductive terminal together form a minor second non-grounding terminal shielding wall, and the minor second non-grounding terminal shielding wall comprises a U-shaped cross-section, allowing the minor second non-grounding terminal shielding wall to provide a shielding wall on at least three sides of the minor second non-grounding conductive terminal.

27. The electrical connector of claim 26, wherein the front end of the electrical connector is an electrical connector front end, and the electrical connector comprises a minor front conductive connecting body, and the minor front conductive connecting body extends at the electrical connector front end and spans over the minor first non-grounding conductive terminal and the minor second non-grounding conductive terminal, electrically connecting to the minor first grounding conductive terminal, the minor second grounding conductive terminal, and the minor third grounding conductive terminal, enabling the minor front conductive connecting body to electrically connect to the minor first non-grounding terminal shielding wall to provide the electrical shielding to the minor first non-grounding conductive terminal at the electrical connector front end, further enabling the minor front conductive connecting body to electrically connect to the minor second non-grounding terminal shielding wall to provide the electrical shielding to the minor second non-grounding conductive terminal at the electrical connector front end, wherein the minor first grounding conductive terminal comprises a minor first grounding terminal front joining structure, the minor second grounding conductive terminal comprises a minor second grounding terminal front joining structure, the minor third grounding conductive terminal comprises a minor third grounding terminal front joining structure, the minor first non-grounding conductive terminal comprises a minor first non-grounding terminal front joining structure, and the minor second non-grounding conductive terminal comprises a minor second non-grounding terminal front joining structure, additionally, the minor first grounding terminal front joining structure, the minor second grounding terminal front joining structure, the minor third grounding terminal front joining structure, the minor first non-grounding terminal front joining structure, and the minor second non-grounding terminal front joining structure are respectively located at the electrical connector front end.

28. The electrical connector of claim 27, wherein the minor front conductive connecting body comprises a minor front wall shielding structure, and the minor front wall shielding structure is provided at the electrical connector front end to serve as a shielding wall for the minor first non-grounding conductive terminal or the minor second non-grounding conductive terminal.

29. The electrical connector of claim 28, wherein the minor front conductive connecting body comprises a minor front connector hollow structure, and the minor front connector hollow structure is hollowed out at the electrical connector front end to provide impedance matching for the minor first non-grounding conductive terminal or the minor second non-grounding conductive terminal.

30. The electrical connector of claim 26, wherein the minor conductive plastic base body extends around one side of the minor first non-grounding conductive terminal and the minor second non-grounding conductive terminal.

31. The electrical connector of claim 26, wherein the minor first grounding conductive terminal is inserted into the minor first conductive plastic wall structure, the minor second grounding conductive terminal is inserted into the minor second conductive plastic wall structure, and the minor third grounding conductive terminal is inserted into the minor third grounding terminal wall structure, allowing the minor first grounding conductive terminal, the minor second grounding conductive terminal, and the minor third grounding conductive terminal to electrically connect to the conductive plastic base.

32. The electrical connector of claim 26, wherein the minor first conductive plastic wall structure abuts against the minor first grounding conductive terminal in surface contact, the minor second conductive plastic wall structure abuts against the minor second grounding conductive terminal in surface contact, and the minor third grounding terminal wall structure abuts against the minor third grounding conductive terminal in surface contact, providing structural support for the minor first grounding conductive terminal, the minor second grounding conductive terminal, and the minor third grounding conductive terminal respectively.

33. The electrical connector of claim 26, wherein the major conductive plastic base body and the minor conductive plastic base body can be formed separately or integrally.
